(19) United States
(12) Patent Application Publication
(10) Pub. No.: US 2025/0197645 A1
(43) Pub. Date: Jun. 19, 2025

(54) RECYCLED FEEDSTOCKS FOR CARBON AND HYDROGEN PRODUCTION

(71) Applicant: Monolith Materials, Inc., Lincoln, NE (US)

(72) Inventors: Enoch E. Dames, Lincoln, NE (US); Peter L. Johnson, Lincoln, NE (US); Christopher J.-P. Cardinal, Lincoln, NE (US); Elliott Wyse, Lincoln, NE (US); Laurent Fulcheri, Lincoln, NE (US)

(21) Appl. No.: 18/963,352

(22) Filed: Nov. 27, 2024

Related U.S. Application Data
(63) Continuation of application No. PCT/US2023/024148, filed on Jun. 1, 2023.
(60) Provisional application No. 63/347,865, filed on Jun. 1, 2022.

(51) Int. Cl. C09C 1/48; C01B 3/24

(52) U.S. Cl. CPC C09C 1/485; C01B 3/24; C01B 2203/0272; C01B 2203/04; C01B 2203/0861; C01B 2203/1241; C01P 2004/04; C01P 2006/12

(57) ABSTRACT

The present disclosure provides systems and methods for making carbon particles. The systems of the present disclosure may include a reactor for pyrolysis of hydrocarbon feedstock to carbon particles. The methods of the present disclosure may include contacting, in a reactor, a non-hydrogenous gas with a hydrocarbon feedstock in presence of a plasma to generate carbon particles and an effluent gas. The effluent gas may comprise hydrogen and the non-hydrogen gas. The method may further include separating at least a portion of the effluent gas into the hydrogen and non-hydrogen gas to obtain a separated gas comprising the non-hydrogenous gas. The separated gas comprising the non-hydrogenous gas may be recycled or otherwise returned to the reactor to generate additional carbon particles and effluent gas.

### CROSS-REFERENCE

This application is a continuation of International Application No. PCT/US2023/024148, filed Jun. 1, 2023, which claims the benefit of U.S. Provisional Application No. 63/347,865, filed Jun. 1, 2022, each of which are entirely incorporated herein by reference.

### BACKGROUND

Carbonaceous materials or hydrogen may be produced by various chemical processes. Performance, energy supply, and environmental performance associated with such chemical processes has evolved over time.

### SUMMARY

The present disclosure provides methods and systems for increasing efficiency of conversion reactions within a reactor. The methods and systems described herein may permit conversion of feedstock to carbon particles at lower temperatures, greater efficiency of material use, and lower equipment wear than other methods and systems. Such improvements may permit scaleup from bench scale to industrial scale to be efficient in terms of energy and material usage and costs.

In an aspect, the present disclosure provides a method for making carbon particles, comprising: (a) in a reactor, contacting a non-hydrogenous gas with a hydrocarbon feedstock in presence of a plasma, thereby obtaining (i) carbon particles and (ii) an effluent gas comprising hydrogen and the non-hydrogenous gas; (b) separating at least a portion of the hydrogen from the non-hydrogenous gas of the effluent gas, thereby obtaining a separated gas comprising the non-hydrogenous gas; (c) providing the separated gas, or derivative thereof, comprising the non-hydrogenous gas to the reactor; and (d) contacting the separated gas, or the derivative thereof, comprising the non-hydrogenous gas with additional hydrocarbon feedstock in presence of the plasma, thereby obtaining (iii) additional carbon particles and (iv) an additional effluent gas comprising hydrogen and the non-hydrogenous gas.

In some embodiments, the non-hydrogenous gas comprises one or more gases selected from the group consisting of nitrogen, helium, neon, krypton, argon, carbon monoxide, and carbon dioxide. In some embodiments, the separated gas, or the derivative thereof, comprises less than or equal to about 50 mole % (mol %) hydrogen. In some embodiments, the separated gas, or the derivative thereof, comprises less than or equal to about 25 mol % hydrogen. In some embodiments, the separated gas, or the derivative thereof, comprises less than or equal to about 10 mol % hydrogen. In some embodiments, the method further comprises, in (a), providing a gas mixture comprising the non-hydrogenous gas and hydrogen to the reactor. In some embodiments, the gas mixture comprises an average molecular weight from about 1 kg/kmol to 90 kg/kmol. In some embodiments, in (a), a ratio of the non-hydrogenous gas to the hydrogen is at least 2 to 1. In some embodiments, the ratio is at least 10 to 1. In some embodiments, the method further comprises, in (c), providing a gas mixture comprising the separated gas, or derivative thereof, and hydrogen to the reactor. In some embodiments, in (d), a ratio of the non-hydrogenous gas to the hydrogen is at least 2 to 1. In some embodiments, the ratio is at least 10 to 1. In some embodiments, during or after (c) no hydrogen is provided to the reactor.

In some embodiments, the carbon particles or the additional carbon particles are carbon black. In some embodiments, the method further comprises, in (a), contacting the non-hydrogenous gas and the hydrocarbon feedstock at a temperature of no more than about 1900° C. In some embodiments, the temperature is no more than about 1800° C. In some embodiments, the method further comprises, in (d), contacting the separated gas and the additional hydrocarbon feedstock at a temperature of no more than about 1900° C. In some embodiments, the temperature is no more than about 1800° C. In some embodiments, the carbon particles or the additional carbon particles have a specific surface area of at least about 40 square meters per gram (m²/g). In some embodiments, the carbon particles or the additional carbon particles have a specific surface area from about 40 m²/g to 200 m²/g. In some embodiments, the carbon particles or the additional carbon particles have a nitrogen surface area (N2SA) of at least about 40 m²/g. In some embodiments, the carbon particles or the additional carbon particles have a dibutyl phthalate (DBP) absorption of at least about 100 milliliters per 100 grams of carbon particles (mL/100 g). In some embodiments, the carbon particles are generated in presence of an additive that disrupts aggregation of the carbon particles. In some embodiments, the additive comprises an alkali metal salt. In some embodiments, the alkali metal salt comprises potassium. In some embodiments, the carbon particles are generated in absence of an additive that disrupts particle aggregation. In some embodiments, the carbon particles are generated in absence of an alkali metal salt. In some embodiments, the carbon particles are generated in absence of potassium.

In some embodiments, in (a), at least about 80% of the hydrocarbon feedstock is converted to the carbon particles. In some embodiments, in (a), at least about 90% of the hydrocarbon feedstock is converted to the carbon particles. In some embodiments, in (a), at least about 95% of the hydrocarbon feedstock is converted to the carbon particles. In some embodiments, in (d), conversion of the additional hydrocarbon feedstock to the additional carbon particles is at least about 80%. In some embodiments, in (d), conversion of the additional hydrocarbon feedstock to the additional carbon particles is at least about 90%. In some embodiments, in (d), conversion of the additional hydrocarbon feedstock to the additional carbon particles is at least about 95%.

In some embodiments, the method further comprises producing the plasma with the aid of an electrode. In some embodiments, through (a)-(d), the electrode is consumed at a rate of no more than about 0.6 kilogram carbon per megawatt hour (kg-carbon/MW-hr). In some embodiments, the reactor comprises one or more graphite components, and wherein the one or more graphite components have a wear rate of less than or equal to about 0.6 kg-carbon/MW-hr. In some embodiments, the method further comprises, in (a) or (d), generating an amount of reactor fouling that is no more than about 4 kilogram carbon fouling per 100 kilograms of carbon injected. In some embodiments, the hydrocarbon feedstock comprises methane. In some embodiments, the method further comprises, prior to (d), providing an external gas to the reactor, wherein the external gas comprises additional non-hydrogenous gas. In some embodiments, a ratio of non-hydrogenous gas to hydrogen is at least about 4 to 1. In some embodiments, the ratio is at least about 10 to 1. In some embodiments, (b) comprises separating at least the portion of the hydrogen from the non-hydrogenous gas using one or more of pressure-swing adsorption, membrane separation, cryogenic separation, absorption column, stripping column, gas compressor, and external supply. In some embodiments, the method further comprises, after (a), separating the carbon particles from the non-hydrogenous gas.

In some embodiments, the method further comprises providing an energy input to generate the plasma, wherein the energy input per kilogram hydrogen produced is at least about 15% less for a gas mixture comprising at least 50 mol % non-hydrogenous gas as compared to another gas mixture comprising greater than or equal to about 80 mol % hydrogen. In some embodiments, a total energy input to obtain the carbon particles and the hydrogen is within about 10% for a gas mixture comprising at least 50 mol % non-hydrogenous gas as compared to another gas mixture comprising greater than or equal to about 80 mol % hydrogen. In some embodiments, greater than or equal to about 90% of the non-hydrogenous gas provided to the reactor is returned to the reactor in the separated gas. In some embodiments, greater than or equal to about 95% of the non-hydrogenous gas provided to the reactor is returned to the reactor in the separated gas. In some embodiments, the method further comprises, prior to (a), providing the non-hydrogenous gas to the reactor in presence of the plasma and in absence of the hydrocarbon feedstock for a time period sufficient for the reactor to reach thermal steady state.

In some embodiments, the method further comprises, in (a) or (d), providing a gas mixture comprising at least 50 mol % of the non-hydrogenous gas and hydrogen to the reactor to generate the carbon particles or the additional carbon particles. In some embodiments, the carbon particles or the additional carbon particles have a DBP structure of at least about 100 mL/100 g. In some embodiments, the carbon particles or the additional carbon particles are native carbon particles, and wherein the native carbon particles have a DBP structure greater than or equal to about 30% larger than other native carbon particles generated in a gas mixture comprising greater than or equal to 80 mol % hydrogen.

In some embodiments, the method further comprises providing a first gas to the reactor with the hydrocarbon feedstock to initiate a reaction to generate the carbon particles and the hydrogen. In some embodiments, the first gas comprises greater than or equal to about 80% hydrogen. In some embodiments, the method further comprises using a quench gas to cool the carbon particles, the additional carbon particles, the effluent, the additional effluent, or any combination thereof. In some embodiments, the quench gas is generated from the effluent gas, and wherein the quench gas comprises from about 0.1 mol % to about 4 mol % hydrocarbons.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 schematically illustrates an example bench scale three-phase plasma pyrolysis system;

FIG. 2 schematically illustrates an example plasma pyrolysis process flow diagram;

FIG. 3 schematically illustrates another example plasma pyrolysis process flow diagram;

FIG. 4 schematically illustrates another example plasma pyrolysis process flow diagram;

FIG. 5 shows an example plot of reactor wall temperature over time;

FIG. 6A shows a transmission electron microscope image of example carbon particles on a two micrometer scale and FIG. 6B shows a transmission electron microscope image of example carbon particles on a two hundred nanometer scale;

FIG. 7 shows an example plot of nitrogen surface area of carbon particles as a function of hydrogen concentration in a reactor;

FIG. 8 shows an example plot of carbon black structure as a function of hydrogen concentration in a reactor;

FIG. 9 shows an example plot of percent residual hydrocarbons as a function of hydrogen concentration in a reactor;

FIG. 10 shows an example plot of carbon recovery and fouling as a function of hydrogen concentration in the reactor; and

FIG. 11 shows an example plot of equipment wear as a function of hydrogen concentration in the reactor.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

As used herein, the term “carbon particle” may refer to a particle comprising carbon. Examples of carbon particles include, but are not limited to, carbon black, nanotubes, carbon nanostructures, graphene, coke, needle coke, graphite, large ring polycyclic aromatic hydrocarbons, activated carbon, or the like, or any combination thereof. Carbon black may include all forms of carbon black including, but not limited to, furnace black, plasma black, thermal black, acetylene black, or any combination thereof. Carbon particles may be classified into grades. The carbon particles of the present disclosure may be of any grade.

As used herein, the term “carbon black” may refer to a nanostructured material with a high carbon content, for example, above 90% by elemental composition. Carbon black may be in the form of fine quasi-spherical particles (e.g., primary particles), which may be connected or aggregated together by covalent links to form aciniform aggregates or other structures. The aggregates can form agglomerates by weak bonds (e.g., van-der Waals forces) that can break under mechanical stress. The average diameter of primary particles may vary between a few tens and a few hundred of nanometers depending on the production process.

As used herein, the term “structure” may refer to the organization of primary particles within the aggregate. A high structure can correspond to an organization that includes a large number of highly- and widely-branched intertwined particles. A low structure can correspond to an organization consisting of isolated particles or aggregates with few branches (agglomeration of a small number of primary particles). The structure may be measured using dibutyl phthalate absorption.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Certain inventive embodiments herein contemplate numerical ranges. When ranges are present, the ranges include the range endpoints. Additionally, every sub range and value within the range is present as if explicitly written out. The term “about” or “approximately” may mean within an acceptable error range for the particular value, which will depend in part on how the value is measured or determined, e.g., the limitations of the measurement system. For example, “about” may mean within 1 or more than 1 standard deviation, per the practice in the art. Alternatively, “about” may mean a range of up to 20%, up to 10%, up to 5%, or up to 1% of a given value. Where particular values are described in the application and claims, unless otherwise stated the term “about” meaning within an acceptable error range for the particular value may be assumed.

The present disclosure may provide thermal plasma processes which may permit economically viable production of hydrogen and carbon black at commercial scale. The systems and methods described herein may provide high reaction selectivity (e.g., hydrogen selectivity of greater than or equal to 95%), high conversion (e.g., greater than or equal to 99% of feedstock may be converted to hydrogen and carbon particles and carbon fouling), and high solid recovery (e.g., greater than or equal to 90% recovery of solid carbon and hydrogen). Solid carbon may include carbon particles and carbon fouling. High conversion of feedstock may include greater than or equal to about 90%, 92%, 94%, 96%, 98%, 99%, or higher conversion. The methods and systems described herein may permit tuning of chemical and physical characteristics of the carbon particles. The methods and systems described herein may permit the production of hydrogen and carbon particles at lower energy than other methods such as, for example, furnace black or water electrolysis production methods.

Thermal plasmas may be useful for the production of hydrogen without producing large carbon dioxide emissions. Thermal plasma technologies may be useable to convert electric energy into thermal energy at high efficiency. Thermal plasmas may allow a flexible and controllable carbon dioxide emission free, or substantially carbon dioxide free, thermal energy supply at high temperature. Thermal plasmas may use various types of gases or gas mixtures. Thermal plasma's may be usable for endothermic processes, which use high temperatures and may be used in place of combustion processes used in the steel and cement industries, oil and gas industries, or chemical and materials industries.

Thermal plasmas may be used for the pyrolysis of methane, or natural gas, for the production of hydrogen without or substantially without the generation of carbon dioxide. Thermal plasmas may permit the generation of hydrogen and solid carbon materials without the production of carbon dioxide or without substantial amounts of carbon dioxide being produced. Pyrolysis of methane using thermal plasmas may be thermodynamically less energy intensive than other hydrogen production methods, such as water dissociation for hydrogen production.

Large scale hydrogen production may be advantageous as an alternative fuel. Hydrogen production methods, such as steam methane reforming (SMR), may produce large amounts of carbon dioxide emissions. For example, SMR may generate on average more than 10 tons of carbon dioxide equivalents per ton of hydrogen produced. Carbon capture and storage (CCS) systems may be used in tandem with SMR to reduce emitted carbon dioxide, but these methods may not be usable at industrial scale.

Water electrolysis may be an option for the production of decarbonized hydrogen (e.g., production of hydrogen without carbon byproducts or products). Water electrolysis may be energy intensive in that it may use at least about 285 kilojoules per mole (kJ/mol) of hydrogen produced.

A pathway based on the pyrolysis of methane at high temperature to produce solid carbon and hydrogen may be as shown in Equation 1:

CH₄ [symbol] C+2H₂ 76 kJ/Mol (1)

At high temperatures, the methane may be disassociated into molecular constituents of carbon and hydrogen gas. Each mole of hydrogen produced from methane includes an energy association of 38 kJ/mol. As a mole of methane may produce two moles of hydrogen the pyrolysis reaction may us approximately 76 kJ/mol. Methane pyrolysis may use approximately seven times less energy per mole of hydrogen produced (e.g., 38 kJ/mol versus 285 kJ/mol). Additionally, methane pyrolysis may permit the production of two recoverable products, solid carbon and hydrogen.

Hot-wall thermal decomposition may be useable for methane pyrolysis. Hydrogen produced in this method may be burned during an aerobic phase to provide a part of the energy used for the feedstock thermal decomposition during the anaerobic phases. This method may not produce hydrogen at commercial scale if the hydrogen is used during the heating cycle. For example, to produce hydrogen at commercial scale electrical heating may be used rather than hydrogen during the aerobic phase. Hydrogen production using hot-wall thermal decomposition may produce gaseous effluents that include impurities, such as Sulphur and Nitrogen oxides. Treatment of the gaseous effluents to remove impurities may increase the complexity and cost of hydrogen production.

Alternatively, thermo-catalytic decomposition may be used for methane pyrolysis. In some cases, despite the moderate endothermicity of methane pyrolysis, a high operating temperature may be used for methane pyrolysis due to the stability of methane. The use of catalysts may permit methane decomposition at a lower temperatures. The use of metal catalysts may increase the complexity of hydrogen and carbon production due to the fast deactivation of such catalysts and the difficulty of separating the catalysts from the produced solid carbon. Carbon based catalysts may be catalytically active for sustaining methane decomposition above 800° C. with an operating range of about 800-900° C. Carbon catalysts may be subject to deactivation, however on usable periods may be longer than for metal catalysts. Methane decomposition may not be supported for more than a few hours by the carbonaceous catalysts. Continuous (re)generation of catalytically active carbons from catalytically inactive carbons may increase the catalytically active period. However, this process may be more expensive and less efficient as compared with the SMR process. Further, the carbon produced may be burned during catalyst regeneration. Highly active catalytic materials may be deactivated by carbon deposition and such catalytic materials may lack mechanical stability during recycling and use. Carbon recovery and separation from the catalyst, as well as contamination of carbon by catalyst fragments reduce product purity. Incomplete decomposition of methane at the end of a single pass can increase the complexity of the systems due to implementation of devices for the separation and recycling of gas.

Alternatively, molten metal bath decomposition may be used for methane pyrolysis. Molten metal bath decomposition may comprise bubbling methane through a hot-walls column filled with molten metal. The methane contained in the bubbles may be progressively decomposed during its ascent in the bath. Hydrogen may then leave the bath as an emanation gas while the solid carbon floats on the liquid surface. Various metals (e.g., Sn, Ga, Bi, Pb, etc.) may be used to enhance heat transfer in the medium while avoiding the carbon sticking to the walls. Other metals (e.g., Ni, Fe, Co, Pd, Pt, etc.) may be used that enhance heat transfer and have a catalytic effect. Many active metals have a melting point above 1000° C. and inert metals may have a melting above 1000° C. which is similar to the thermal methane decomposition threshold. Therefore, the maximum temperature of the molten bath may be around 1000° C. which may generate an upper threshold for the methane decomposition rate. Additionally, this method may result in difficult separation and recovery of carbon low-value morphologies that may be contaminated by metals used for the bath.

Alternatively, solar decomposition may be used for methane pyrolysis. Concentrated solar light may be used to heat-up walls of a reactor or directly heat a gas inside via suspended particles. This method may use either indirect solar heating or direct solar heating. Indirect solar heating may use a pyrolysis reactor that is heated from an external wall that is subjected to concentrated solar light. Direct solar heating may use a pyrolysis reactor that is heated from the inside by light absorbent particles in suspension in the process gas. The light absorbent particles may receive solar light from a window. The particles may be the carbon particles produced by decomposition of methane or neutral particles used as heat carriers and catalysts. Efficiency of direct solar heating process may be reduced by fast window clouding while an indirect solar heating process may have reduced efficiency due to poor thermal yield. Quality control of the carbon produced and the cost of solar power plants also may reduce the economic viability of such processes at commercial scale.

The use of non-thermal plasmas for methane pyrolysis may be another possible process for producing hydrogen, where lower temperature molecular decomposition can be performed using electrical processes. A non-thermal plasma may be an ionized gas which remains ionized at low temperature (e.g., tens to hundreds of degrees Celsius) because of its relatively low ionization rate. Non-thermal plasma may have a significant chemical activity due to the presence of high-energy free electrons. Generation of non-thermal plasmas may consume large amounts of electricity resulting in high electrical costs for generating solid carbon and hydrogen. The technology may suffer from an incomplete conversion of methane to hydrogen which may result in greater capital and process cost in order to separate the hydrogen and recycle unreacted methane. Further, the solid carbon co-produced with the hydrogen may be relatively low value as compared to other methane pyrolysis processes. Therefore, the use of non-thermal plasma may not be competitive for commercial scale hydrogen and carbon production.

Thermal plasmas may allow energy to convert from electric energy to thermal energy. The efficiency of this energy conversion may increase as the size of the plasma generator increases. Contrary to non-thermal plasmas, the ionization rates may be high enough to induce Joule heating. Thermal plasmas may permit flexible and controllable energy supply directly into the gas volume at high to very high temperatures and, potentially, without direct carbon dioxide emissions. Thermal plasmas may be adapted to endothermic processes that use high or very high temperatures in the gas volume.

Carbon black particles may comprise small crystallites having a turbostratic atomic arrangement. Carbon black particles may also contain a graphitic type of crystal structure with an interlayer crystal spacing (d002 spacing) similar to that of graphite when compared to turbostratic carbon.

Carbon black properties may depend on synthesis conditions which include but are not limited to feedstock, heating medium, thermal histories, and reactor configurations. There are a broad ranges of carbon nanoparticles utilized in the tire, industrial rubber, and pigment industry. Carbon nanoparticles may be classified as carbon black that may be characterized by their surface area and structural properties. Depending on the magnitude of both the surface area and structure number, different carbon black grades can be used in different applications and consequently have different physical properties and economic value associated with them. Improving manufacturing processes to master producing a wide range of carbon black grades and leverage pyrolytic and electric processes over conventional combustion-based processes may be of interest.

Industrial applications for carbon black properties may depend on a large number of physicochemical parameters. For use in elastomer compounds (e.g., tires) the average diameter of the particles and the structure of carbon black aggregates may be of particular use. Native carbon blacks may have low or no porosity, and therefore there may be a direct relationship between the particle size and specific surface area measurement (BET) expressed in square meters per gram (m²/g). A metric for quantifying structure can be the Oil Absorption Number (OAN), which may be the amount of oil a given quantity of carbon black can absorb in units of milliliter (mL) oil per 100 grams (g) of carbon black. The OAN may be measured by adding oil (e.g., dibutyl phthalate (DBP)) to a sample of carbon black under constant agitation and measuring the resistance to shear. The OAN may be the amount of oil added in mL per 100 grams of carbon black that generates the maximum resistance to agitation. American Society for Testing and Materials (ASTM) procedures can be utilized to characterize carbon black particles, for example, ASTM D6556 Total and External Surface Area by Nitrogen Adsorption and ASTM D2414 Oil Absorption Number (OAN).

The formation of carbon black from methane pyrolysis may follow an ultra-fast continuous dehydrogenation process of different hydrocarbon compounds. Methane pyrolysis may comprise rupture of C—H bonds via unimolecular decomposition and the subsequent evolution of thermodynamically more stable C—C and C═C bonds at high temperature, thus generation of alkene and alkyne precursors can occur. Acetylene may be stable at high temperature and may be a major precursor. The precursors can react with each other to gradually form aromatic compounds, or polycyclic aromatic hydrocarbons (PAHs). Different PAH formation mechanisms may be identified, but a mechanism is denoted the H-Abstraction-Acetylene-Addition (HACA) mechanism. The kinetics of the HACA mechanism may decrease as clusters grow, due to the increase in the energy barrier. PAHs can grow in size and undergo reaction or condensation. Van der Waals' forces can play a role in the HACA mechanism. Alternatively, or in addition to, the high process temperatures (e.g., 2000 K) may facilitate covalent bond formation. This first operation of PAHs collision may be the “nucleation process,” with nuclei comprised of 10-20 aromatic rings. This nucleation process may lead to the formation of viscous tar nano-droplets by coalescing collision of nuclei. Solidification of these droplets, also called “maturation,” may occur through an internal rearrangement of PAHs into turbostratic layers, as well as a gradual loss of hydrogen within the particle. Particles can progressively evolve from viscous to solid. Once this state is reached, the collision growth mechanism may switch from a coalescing mode to a continuous aggregation process to form larger aggregates and agglomerates with a fractal organization. Depending on the reactor type and configuration, all of the aforementioned processes may be happening sequentially or simultaneously.

A plasma direct methane decarbonization (DMD) process may permit the co-production of hydrogen and solid carbon by pyrolysis of natural gas, or other hydrocarbon feedstock, at very high temperatures with low carbon dioxide emissions using a carbon-free electrical energy source. Such processes, as described elsewhere herein, may produce hydrogen and high-quality carbon particles (e.g., carbon black) at high yields that may not have been previously obtained. Further, the carbon particles produced in a plasma DMD process may have similar features to those found in commercial grade furnace carbon blacks.

Plasma DMD processes may use highly pure hydrocarbon feedstocks (e.g., natural gas) and electricity, such as decarbonized electricity. The economic viability of plasma DMD may depend on (i) the cost of natural gas, (ii) cost of electricity, and (iii) value of carbon produced. Such processes may produce up to 250 kilograms (kg) of hydrogen and 750 kg of carbon particles per one ton of methane. The energy intensity of hydrogen production of a scaled up plasma DMD process may be less than the energy intensity of hydrogen production from water electrolysis processes. For example, the described plasma process may use about 18 to 25 kilowatt-hour per kg of hydrogen produced (kWh/kg H₂) as compared to the about 60 kWh/kg H₂ of a water electrolysis process.

The reactor system and methods described herein may permit high yield production of carbon particles and hydrogen at lower energy and carbon dioxide byproduct production than other systems and methods. Carbon particle and hydrogen yields may be increased without increasing reaction temperatures by dilution of produced hydrogen, for example, by removal of produced hydrogen or addition of non-hydrogenous gases to the system. Systems with improved yields of carbon and hydrogen may provide a viable alternative to other hydrogen (e.g., water electrolysis, SMR with CCS, etc.) and carbon production (e.g., furnace black, etc.). Carbon particle and hydrogen production via thermal plasma processes described herein may provide environmental benefits as compared to other processes, such as a higher carbon intensity and lower energy intensity.

Carbon particles, such as carbon black, may be usable for reinforcing polymers, for example, to reinforce tires. Performance of carbon black in such applications may be modulated by changes in particle surface area and structure. Modulating or otherwise tuning specific surface area and structure of the carbon particles produced may permit production of particles with predetermined properties. Furnace black reactors may use rate of feedstock mixing or quenching (e.g., rapid cooling) of the reactor gas less than ten milliseconds after particle formation to increase surface area and structure of the carbon particles. Such methods may be insufficient for generating high surface area particles in plasma pyrolysis processes. The methods and systems described herein may be useable for generating high surface area and otherwise tunable carbon particles using plasma pyrolysis. For example, surface area of carbon particles produced using gas phase hydrocarbon may be increased by reducing hydrogen content of the gaseous mixture or increasing the average molecular weight of the reaction gases (e.g., plasma gas). Reducing hydrogen content in the reactor may provide additional operational benefits such as, for example, permitting high product yields at lower reaction temperatures, accelerating hydrocarbon conversion to carbon and hydrogen, reducing reactor fouling, or reducing hydrogen erosion of reactor component as compared to similar systems with high hydrogen content.

### Systems and Methods for Generating Carbon Particles

In an aspect, the present disclosure provides a method for making carbon particles. The method may comprise, in a reactor, contacting a non-hydrogenous gas with a hydrocarbon feedstock in presence of a plasma to generate carbon particles and an effluent gas. The effluent gas may include hydrogen, the non-hydrogenous gas, or both. At least a portion of the hydrogen may be separated from the non-hydrogenous gas of the effluent gas to obtain a separated gas comprising the non-hydrogenous gas. The separated gas, or a derivative thereof, may be provided to the reactor. In the reactor, the separated gas, or derivative thereof, may be contacted with additional hydrogen feedstock in presence of the plasma to generate additional carbon particles and additional effluent gas comprising the hydrogen and non-hydrogenous gas.

The present disclosure provides systems and methods for affecting chemical changes. Affecting such chemical changes may include, for example, generating carbonaceous material, hydrogen, or a combination thereof using the systems and methods described herein. A carbonaceous material may be solid. A carbonaceous material may comprise or be, for example, carbon particles, a carbon-containing compound or a combination thereof. A carbonaceous material may include, for example carbon black. The systems (e.g., apparatuses) and methods of the present disclosure, and processes implemented with the aid of the systems and methods herein, may allow continuous production of, for example, carbonaceous material, hydrogen, or combination thereof. The processes may include converting a feedstock (e.g., one or more hydrocarbons). The systems and methods described herein may include heating one or more hydrocarbons rapidly to form, for example, carbonaceous material, hydrogen, or combination thereof. For example, one or more hydrocarbons may be heated rapidly to form carbon particles, hydrogen, or combination thereof. Hydrogen may in some cases refer to majority hydrogen (H₂). For example, some portion of this hydrogen may also contain methane (e.g., unspent methane) or various other hydrocarbons (e.g., ethane, propane, ethylene, acetylene, benzene, toluene, polycyclic aromatic hydrocarbons (PAHs) such as naphthalene, etc.). The hydrocarbons may also be in the form of Renewable natural gas, biogas, tall oil, pine oil, biodiesel, or precursors or derivatives thereof or other bio-sourced carbonaceous feedstocks. The feedstock may be solid, for instance any solid that may be treated with a plasma upstream of the conversion vessel to provide a feedstock of gaseous or liquid fuel into the process.

The present disclosure provides examples of such systems and methods, including, for example, the use of plasma technology in pyrolytic decomposition (e.g., pyrolytic dehydrogenation) of natural gas to carbonaceous material (e.g., solid carbonaceous material, such as, for example, carbon particles), hydrogen, or combination thereof. Pyrolytic decomposition (e.g., pyrolytic dehydrogenation) may refer to thermal decomposition of materials at elevated temperatures (e.g., temperatures greater than about 800° C.) in an inert or oxygen-free environment or atmosphere. The temperature of a reactor may be increased to increase the conversion of feedstock into carbon particles, hydrogen, or combination thereof. The temperature of a reactor can be increased to selectivity produce hydrogen, carbon particles, or combinations thereof. The temperature of a reactor can be tuned to increase or decrease the surface area of carbon particles. Increasing temperatures can increase the kinetic rates of feedstock decomposition as well as the intermediate operations which can produce formation of carbon particles and hydrogen. Increasing reactor temperature can increase the rate of carbon particle aging and can reduce reactor wall fouling. This may be due to reducing the time before the carbon particles are chemically inert.

The systems and processes described herein may include a series of unit operations such as, but not limited to, processing reaction products, separating solid and gaseous products, purifying gaseous streams, or any combination thereof. The carbon and hydrogen production system may include, but is not limited to, a reactor unit, heat exchanger unit, filter unit, pelletizer unit, gas purification unit, or any combination thereof. A gas purification unit may include a pressure swing adsorption process, membrane separation unit, absorption or stripper separation unit, cryogenic separation unit, gas compressor, impurity removal system, or any combination thereof. Gas purification and re-injection to the reactor may result in broader capability to generate a broader range of useful carbon particle (e.g., carbon black) grades, increased product yields, and reduced feedstock costs. Recycled and purified reaction gases can be recycled to the plasma generating electrodes of the reactor. Alternatively, or in addition to, externally supplied gas may be delivered into the plasma and reaction vessel. The composition of the supplied gas, flow rate of the supplied gas, gas density, and other process factors may modify the plasma arc characteristics, carbon nanostructure formation, carbon nanostructure physical properties, or any combination thereof. Controlling molecular weight and compositions of the delivered gases into the reactor may broaden carbon nanostructure production capabilities, improve overall yields, and reduce feedstock costs for plasma pyrolysis to produce solid carbon particles and hydrogens.

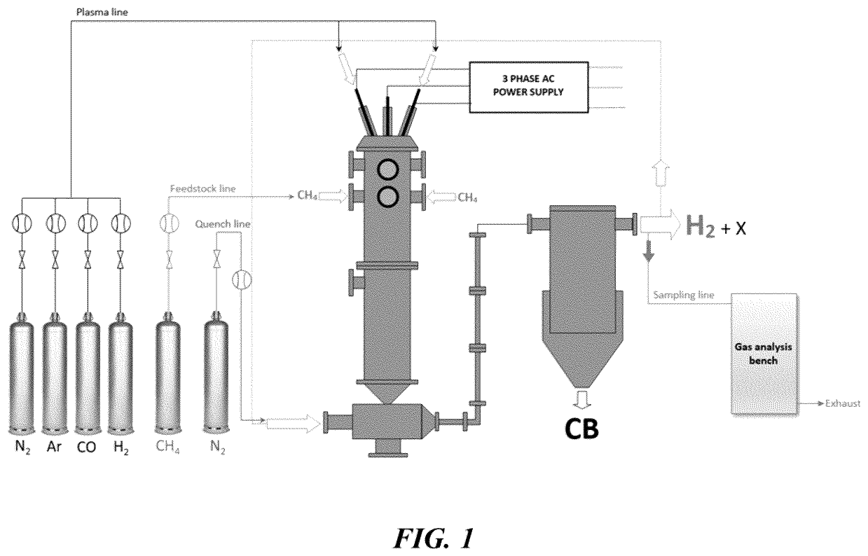

FIG. 1 schematically illustrates an example bench scale three-phase plasma pyrolysis system for the production of carbon particles and hydrogen. The bench scale three-phase plasma pyrolysis may include gas supply system, plasma source, pyrolysis reactor, filter system, water-cooling bench, output gas analysis bench, or any combination thereof. The gas supply system may manage routing of the input gas which may include, but is not limited to hydrogen, nitrogen, carbon monoxide, carbon dioxide, argon, krypton, neon, methane, or any combination thereof. The gas supply system may provide a non-hydrogenous gas, hydrogen gas or both to the reactor prior to injection of a hydrocarbon feedstock. In an example, the non-hydrogenous gas or hydrogen gas may be provided to the reactor either through the plasma generating electrodes or adjacent to the plasma generating electrodes to permit generation of the plasma. The electrodes may have one or more fluid flow pathways that permit the non-hydrogenous or hydrogen gas to flow through the electrode(s). The non-hydrogenous gas (e.g., nitrogen, argon, etc.) may be usable to generate a plasma and the plasma may be usable to heat the reactor. The gas supply system may provide a hydrocarbon feedstock to the system. The hydrocarbon feedstock may be provided with the non-hydrogenous or hydrogen gas or separate from the non-hydrogenous or hydrogen gas. As shown in FIG. 1, the hydrocarbon feedstock may be provided to the reactor downstream of the non-hydrogenous or hydrogen gas. The carbon particles and effluent gas may be provided to a quenching unit configured to cool the solid and gas products for downstream processing. The solid material may be separated from the gaseous materials and, in some cases, at least a portion of the gaseous material may be recycled or otherwise returned to the reactor.

The hydrogen or non-hydrogenous gas may be heated using electrical energy (e.g., from a DC or AC source). The electrical energy may be provided by one or more plasma generating electrodes disposed in the plasma generating section of a reactor. The one or more plasma generating electrodes may be configured to or may heat a thermal transfer gas in the plasma generating section. Any description of heating a gas or of heating one or more gases herein may equally apply to heating a gaseous mixture (e.g., at least 50% by volume gaseous) with a corresponding composition at least in some configurations. The gaseous mixture may comprise, for example, a mixture of individual gases, liquids, or a mixture of individual gas-liquid mixtures. Any description of a gas herein may equally apply to a liquid or gas-liquid mixture with a corresponding composition at least in some configurations. The one or more gases may be heated by an electric arc. The arc may be controlled through the use of a magnetic field which may move the arc in a circular fashion rapidly around the electrode tips. The electrodes may or may not be oriented parallel to an axis of the reactor or to each other. The electrode(s) may comprise a complex shape. A hydrocarbon (e.g., feedstock) may be injected through various injector configurations. For example, the hydrocarbon (e.g., the feedstock) may be injected at injector through the center of concentric electrodes.

The systems described herein may comprise plasma generators. The plasma generators may utilize a gas (e.g., plasma gas, reactor gas, etc.) or gaseous mixture (e.g., at least 50% by volume gaseous). The plasma generators may utilize a gas or gaseous mixture (e.g., at least 50% by volume gaseous) where the gas is reactive and corrosive in the plasma state. The plasma generators may be plasma torches. The systems described herein may comprise plasma generators energized by a DC or AC source. The gas or gas mixture may be supplied directly into a zone in which an electric discharge produced by the DC or AC source is sustained. The plasma may have a composition as described elsewhere herein (e.g., in relation to composition of the one or more gases). The plasma may be generated using arc heating. The plasma may be generated using inductive heating. The plasma may be generated using DC electrodes. The plasma may be generated using AC electrodes. For example, a plurality (e.g., 3 or more) of AC electrodes may be used (e.g., with the advantage of more efficient energy consumption as well as reduced heat load at the electrode surface).

The plasma generator may be operated at a suitable power. The power may be, for example, greater than or equal to about 0.5 kilowatt (kW), 1 kW, 1.5 kW, 2 kW, 5 kW, 10 kW, 25 kW, 50 kW, 75 kW, 100 kW, 150 kW, 200 kW, 250 kW, 300 kW, 350 kW, 400 kW, 450 kW, 500 kW, 550 kW, 600 kW, 650 kW, 700 kW, 750 kW, 800 kW, 850 kW, 900 kW, 950 kW, 1 megawatt (MW), 1.05 MW, 1.1 MW, 1.15 MW, 1.2 MW, 1.25 MW, 1.3 MW, 1.35 MW, 1.4 MW, 1.45 MW, 1.5 MW, 1.6 MW, 1.7 MW, 1.8 MW, 1.9 MW, 2 MW, 2.5 MW, 3 MW, 3.5 MW, 4 MW, 4.5 MW, 5 MW, 5.5 MW, 6 MW, 6.5 MW, 7 MW, 7.5 MW, 8 MW, 8.5 MW, 9 MW, 9.5 MW, 10 MW, 10.5 MW, 11 MW, 11.5 MW, 12 MW, 12.5 MW, 13 MW, 13.5 MW, 14 MW, 14.5 MW, 15 MW, 16 MW, 17 MW, 18 MW, 19 MW, 20 MW, 25 MW, 30 MW, 35 MW, 40 MW, 45 MW, 50 MW, 55 MW, 60 MW, 65 MW, 70 MW, 75 MW, 80 MW, 85 MW, 90 MW, 95 MW or 100 MW. Alternatively, or in addition, the power may be, for example, less than or equal to about 100 MW, 95 MW, 90 MW, 85 MW, 80 MW, 75 MW, 70 MW, 65 MW, 60 MW, 55 MW, 50 MW, 45 MW, 40 MW, 35 MW, 30 MW, 25 MW, 20 MW, 19 MW, 18 MW, 17 MW, 16 MW, 15 MW, 14.5 MW, 14 MW, 13.5 MW, 13 MW, 12.5 MW, 12 MW, 11.5 MW, 11 MW, 10.5 MW, 10 MW, 9.5 MW, 9 MW, 8.5 MW, 8 MW, 7.5 MW, 7 MW, 6.5 MW, 6 MW, 5.5 MW, 5 MW, 4.5 MW, 4 MW, 3.5 MW, 3 MW, 2.5 MW, 2 MW, 1.9 MW, 1.8 MW, 1.7 MW, 1.6 MW, 1.5 MW, 1.45 MW, 1.4 MW, 1.35 MW, 1.3 MW, 1.25 MW, 1.2 MW, 1.15 MW, 1.1 MW, 1.05 MW, 1 MW, 950 kW, 900 kW, 850 kW, 800 kW, 750 kW, 700 kW, 650 kW, 600 kW, 550 kW, 500 kW, 450 kW, 400 kW, 350 kW, 300 kW, 250 kW, 200 kW, 150 kW, 100 kW, 75 kW, 50 kW, 25 kW, 10 kW, 5 kW, 2 kW, 1.5 kW or 1 kW.

A feedstock may be provided to the reactor. At least one reaction gas (e.g., any non-feedstock gas provided to a reactor in accordance with the present disclosure) may be provided to the reactor. A hot gas may be generated (e.g., in the reactor or plasma generating section) through the use of a thermal generator (e.g., in an upper portion of the reactor or plasma generating section). For example, the hot gas may be generated in an upper portion of the reactor through the use of one or more AC electrodes (e.g., three or more AC electrodes), through the use of DC electrodes (e.g., concentric DC electrodes), or through the use of a resistive or inductive heater. The hot gas may be generated by heating at least a subset of one or more gases (e.g., a feedstock alone or in combination with at least one process gas) using the AC electrodes, the DC electrodes, or the resistive or inductive heater. The heating may include directly heating a hydrocarbon (e.g., the feedstock). For example, the hydrocarbon (e.g., the feedstock) may be added to the thermal generator (e.g., at a pressure described elsewhere herein). For example, the hydrocarbon (e.g., the feedstock) may be added through direct injection into the plasma. The reactor (or at least a portion thereof, such as, for example, at least a portion of an inner wall of the reactor) may comprise a liner (e.g., a refractory liner). A hydrocarbon (e.g., the feedstock) may be provided to the reactor. For example, the hydrocarbon (e.g., the feedstock) may be injected into the reactor through one or more injectors. Alternatively, or in addition, the hydrocarbon (e.g., the feedstock) may be provided through one or more inlet ports (e.g., in a wall of the reactor). The hydrocarbon may be injected at or near the source point of the plasma generation (e.g., adjacent to plasma generating electrode(s)) or downstream or even upstream of the source of the thermal plasma. Any description to number or location of injectors herein may equally apply to inlet ports at least in some configurations, and vice versa. One or more process gases may be provided through one or more inlet ports (e.g., the same or different than the hydrocarbon or feedstock) or through at least a subset of the one or more injectors. A given process gas may be provided together with a feedstock, separately from the feedstock or a combination thereof (e.g., the given process gas may be provided with the feedstock, and either the given process gas or a different process gas may be provided separately from the feedstock (e.g., as purge)). A given process gas may or may not be heated by the thermal generator.

A process gas provided with the feedstock or in parallel with the feedstock may be heated. A process gas may modify the environment or atmosphere in or around at least a portion of the reactor, the thermal generator, inlet port(s), or injector(s), purge at least a portion of the reactor, the thermal generator, inlet port(s) or injector(s), or any combination thereof. For example, an inlet port, an array of inlet ports or a plenum (e.g., at the top of a reactor) may be used to purge at least a portion of the reactor (e.g., one or more walls), one or more other inlet ports or one or more injectors (e.g., as described in greater detail elsewhere herein). Any description of an inlet port herein may equally apply to an array of inlet ports or a plenum at least in some configurations, and vice versa. The one or more gases (e.g., a feedstock alone or in combination with at least one process gas) that are heated with electrical energy may comprise substantially only the hydrocarbon (e.g., the feedstock). For example, the one or more gases that are heated with electrical energy may comprise the feedstock, and either no process gases, or process gas(es) at purge level(s) or some process gas(es) added with the feedstock (e.g., the one or more gases that are heated with electrical energy may comprise the feedstock and process gas(es) at purge level(s)). As the hydrocarbon (e.g., feedstock) that is heated comprises substantially only freshly supplied hydrocarbon, such a configuration may be referred to herein as a “once-through process.” Alternatively, the one or more gases that are heated with electrical energy may comprise greater level(s) of process gas(es). Levels of a given process gas or a sum of a subset or of all process gases (e.g., on a per mole of feedstock basis) and percentage of process gas(es) heated with electrical energy may be as described elsewhere herein. In some cases, where DC electrodes are used, two electrodes can be used. In some cases, where DC electrodes are used, a multiple of two electrodes can be used (e.g., 2, 4, 6, etc.). AC electrodes may be used in single phase or triple phase configurations. When a single phase AC configuration is used, a multiple of two electrodes may be used (e.g., 2, 4, 6, 8, etc.). When a triple phase AC configuration is used, a multiple of 3 electrodes can be used (e.g., 3, 6, 9, etc.). Each electrode can have an associated injector. For example, a triple phase three electrode configuration can comprise three injectors positioned above the plane of the electrodes.

The electrodes may be cylindrical in shape. The electrodes may be movable via a screw system working in concert with the sliding seal associated with the electrode. The screw system may be water cooled. Use of the movable electrodes may enable continuous operation of the reactor. For example, additional electrode material can be joined to the ends of the electrodes outside of the reactor and, as the electrodes are degraded in the reactor, new electrode material can be fed into the reactor. In this example, the ability to add new electrode material outside of the reactor during reactor operation can provide for continuous or substantially continuous operation of the reactor. In some cases, the electrodes comprise graphite (e.g., synthetic graphite, natural graphite, semi graphite, etc.), carbonaceous materials and resins or other binders, carbon composite materials, carbon fiber materials, or the like, or any combination thereof. The electrodes may be at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, or more inches in diameter. The electrodes may be at most about 40, 35, 30, 29, 28, 27, 26, 25, 24, 23, 22, 21, 20, 19, 18, 17, 16, 15, 14, 13, 12, 11, 10, 9, 8, 7, 6, 5, 4, 3, 2, 1, or fewer inches in diameter. The electrodes may be at least about 1, 2, 3, 4, 5, 6, 7, 8, 9, 10, 11, 12, 13, 14, 15, 16, 17, 18, 19, 20, 21, 22, 23, 24 or more feet in length. The electrodes may be at most about 24, 23, 22, 21, 20, 19, 18, 17, 16, 15, 14, 13, 12, 11, 10, 9, 8, 7, 6, 5, 4, 3, 2, 1, or less feet in length. The distance between the center point of the electrode arc and the wall of the reactor may be at least about 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, or more meters. The distance between the center point of the electrode arc and the wall of the reactor may be at most about 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, 0.1, or fewer meters. Too great of a distance can generate recirculation of gases back into the plasma region, while too short of a distance can cause the wall of the reactor to degrade. In some cases, an electrode can have a mass of at least about 20, 100, 200, 300, 400, 500, 600, 700, 800, 900, 1,000, 10,000, 20,000, 30,000 40,000, or more kilograms. In some cases, an electrode can have a mass of at most about 40,000, 30,000, 20,000, 10,000, 1,000, 900, 800, 700, 600, 500, 400, 300, 200, 100, 20, or fewer kilograms.

Electrodes (e.g., AC or DC electrodes of a plasma generator) in accordance with the present disclosure (or portions thereof) may be placed at a given distance (also “gap” or “gap size” herein) from each other. The gap between the electrodes (or portions thereof) may be, for example, less than or equal to about 40 millimeters (mm), 39 mm, 38 mm, 37 mm, 36 mm, 35 mm, 34 mm, 33 mm, 32 mm, 31 mm, 30 mm, 29 mm, 28 mm, 27 mm, 26 mm, 25 mm, 24 mm, 23 mm, 22 mm, 21 mm, 20 mm, 19 mm, 18 mm, 17 mm, 16 mm, 15 mm, 14 mm, 13 mm, 12 mm, 11 mm, 10 mm, 9 mm, 8 mm, 7 mm, 6 mm, 5 mm, 4 mm, 3 mm, 2 mm or 1 mm. Alternatively, or in addition, the gap between the electrodes (or portions thereof) may be, for example, greater than or equal to about 0.5 mm, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm or 35 mm.

The reactor may include a one or more reactor walls. The external boundary (e.g., reactor wall) may comprise a liquid- or gas-cooled double wall vessel. In an example, the reactor wall comprises a liquid-cooled double wall vessel. Thermal energy may be removed from the reactor by a cooling circuit coupled to the reactor vessel. Thermal energy may be removed at a rate to maintain thermal steady state of the reactor. The vessel wall may be formed of any thermally stable and thermally conductive material, such as stainless steel, carbon steel, mild steel, nickel alloys, or any combination thereof. In an example, the vessel is formed of stainless steel.

The hydrocarbon feedstock can be injected adjacent to one or more electrodes. The hydrocarbon can be injected in close proximity to one or more electrodes. In some cases, the hydrocarbon is injected at a distance from the electrodes of about 1 mm to about 1,000 mm. In some cases, the hydrocarbon is injected at a distance from the electrodes of about 1 mm to about 5 mm, about 1 mm to about 10 mm, about 1 mm to about 100 mm, about 1 mm to about 1,000 mm, about 5 mm to about 10 mm, about 5 mm to about 100 mm, about 5 mm to about 1,000 mm, about 10 mm to about 100 mm, about 10 mm to about 1,000 mm, or about 100 mm to about 1,000 mm. In some cases, the hydrocarbon is injected at a distance from the electrodes of about 1 mm, about 5 mm, about 10 mm, about 100 mm, or about 1,000 mm. In some cases, the hydrocarbon is injected at a distance from the electrodes of at least about 1 mm, about 5 mm, about 10 mm, or about 100 mm. In some cases, the hydrocarbon is injected at a distance from the electrodes of at most about 5 mm, about 10 mm, about 100 mm, or about 1,000 mm.

The pressure at the tip of any of the injectors may be the same as the pressure of the surrounding reactor. In some cases, the pressure at the tip of any of the injectors is greater than the pressure of the surrounding reactor. In some cases, the pressure at the tip of any of the injectors is within 20% of the pressure of the surrounding reactor. In some cases, the pressure at the tip of any of the injectors is within 10% of the pressure of the surrounding reactor. In some cases, the pressure at the tip of any of the injectors is within 5% of the pressure of the surrounding reactor. In some cases, the pressure at the tip of any of the injectors is within 1% of the pressure of the surrounding reactor.

The electrodes, injectors, or both may possess an angle of inclination (e.g., an angle between the long axis of the electrode or injector and the length axis of the reactor) of at least about 0, 5, 10, 15, 20, 25, 30, 35, 40, 45, 50, 55, 60, 65, 70, 75, 80, 85, 90, or more degrees. The electrodes or the injectors may possess an angle of inclination of at most about 90, 85, 80, 75, 70, 65, 60, 55, 50, 45, 40, 35, 30, 25, 20, 15, 10, 5, 0, or less degrees. The electrodes or injectors may possess an angle on inclination in a range as defined by any two of the proceeding values. For example, the electrodes and injectors may have an angle of inclination between about 15 and about 30 degrees. Higher angles of inclination may provide increased torch stability. The injectors may be tilted or positioned in such a way as to provide a tangential component to the injection velocity. The injectors can comprise a heat resistant material (e.g., metals, tungsten, graphite, metal carbides, ceramic materials, alumina, silica, aluminosicates, glasses, etc.). For example, the injectors can be formed of metal (e.g., copper, stainless steel, Inconel, etc.). The injectors can be water cooled. The injectors can be configured to provide additional additives in addition to the feedstocks to the reactor.

Injectors in accordance with the present disclosure (or portions thereof) may comprise or be one or more suitable materials, such as, for example, copper, stainless steel, graphite, alloys (e.g., of high temperature corrosion resistant metals) or other similar materials (e.g., with high melting points and good corrosion resistance). The injector(s) may be cooled via a cooling fluid. The injector(s) may be cooled by, for example, water or a non-oxidizing liquid (e.g., mineral oil, ethylene glycol, propylene glycol, synthetic organic fluids such as, for example, DOWTHERM™ materials, etc.). The injectors may also be cooled with a gas (e.g., hydrogen, nitrogen, helium, argon, etc.).

The reactor may comprise one or more injectors configured to inject or may inject the non-hydrogenous gas, hydrocarbon feedstock, separated gas, or any combination thereof into the reactor. The one or more injectors may be substantially the same or may be the same. Alternatively, or in addition to, the individual gases injected into the reactor may be injected via injectors configured to inject the specific gas or gas mixture. For example, each type of gas injected may be injected through a unique injector configured for that specific gas or gas mixture. The injectors may be designed or modified based on the physical properties of the gas or gas mixture being injected into the reactor. The injectors may be designed to permit a uniform stream of gas or gas mixture through the exit port of the injector such that the total flow of the incoming gas through all injectors is matched to the orthogonal, partially orthogonal or parallel flow of process gas in the reactor. Tuning the flow of process gas in the reactor may permit the produced carbon particles to be tuned. In an example, the feedstock includes a liquid component and a liquid atomizing assembly is included in the nozzle design of the injector. The liquid atomizing assembly may permit delivery of droplets of 10 micron in size or larger. In an example, the feedstock includes liquid component(s) in the gas phase and the injector assembly may be heated or insulated to prevent condensation of liquid onto the inner surface of the injector. Non-hydrogenous gas may be injected into the system as a heat carrier that may be mixed with carbonaceous feedstock. A non-hydrogenous gas injector may be a plenum at the top of the plasma chamber that feeds the gases at a sheath, annulus or main gas flow through the center of the electrodes for a concentric ring DC two electrode system. For an AC system, the gas may be fed through the plenum directly into the plasma that is generated by the electrodes. The injectors or plenums may be configured to mix or may otherwise distribute the gas through the reactor.

The one or more additives may be added to the reactor via an injector. The additives may be added to the reactor in tandem with the hydrocarbon feedstock (e.g., through the same injector) or via a different injector. The one or more additives may comprise one or more suitable compounds (e.g., in a vaporized state; in a molten state; dissolved in water, an organic solvent (e.g., liquid feedstock, ethylene glycol, diethylene glycol, propylene glycol, diethyl ether or other similar ethers, or other suitable organic solvents) or a mixture thereof; etc.). For example, structure (e.g., DBP) may be at least in part controlled with the aid of a suitable ionic compound, such as, for example, an alkali metal salt (e.g., acetate, adipate, ascorbate, benzoate, bicarbonate, carbonate, citrate, dehydroacetate, erythorbate, ethyl para-hydroxybenzoate, formate, fumarate, gluconate, hydrogen acetate, hydroxide, lactate, malate, methyl para-hydroxybenzoate, orthophenyl phenol, propionate, propyl para-hydroxybenzoate, sorbate, succinate or tartrate salts of sodium, potassium, rubidium or caesium). Adding an ionic compound to the reactor during particle formation may disrupt particle aggregation and decrease the structure of the carbon particles. In an example, an additive, such as potassium, is added to the reactor In another example, no additives are added to the reactor. Such compound(s) may be added at a suitable level with respect to (or in relation to) the feedstock and/or thermal transfer gas (e.g., the compound(s) may be added at a ratio or concentration between about 0 ppm and 2 ppm, 0 ppm and 5 ppm, 0 ppm and 10 ppm, 0 ppm and 20 ppm, 0 ppm and 50 ppm, 0 ppm and 100 ppm, 0 ppm and 200 ppm, 0 ppm and 500 ppm, 0 ppm and 1000 ppm, 0 ppm and 2000 ppm, 0 ppm and 5000 ppm, 0 ppm and 1%, 5 ppm and 50 ppm, 10 ppm and 100 ppm, 20 ppm and 100 ppm, 100 ppm and 200 ppm, 100 ppm and 500 ppm, 200 ppm and 500 ppm, 10 ppm and 2000 ppm, 100 ppm and 5000 ppm, 1000 and 2000 ppm, 2000 ppm and 5000 ppm, 2000 ppm and 1% or 5000 ppm and 1% (e.g., of the cation) on a molar or mass basis with respect to, for example, the feedstock flow rate and/or the thermal gas flow rate, or with respect to the amount of carbon added with the feedstock).

The hydrocarbon feedstock may include any chemical with formula CₙHₓ or CₙHₓO_{y}, where n is an integer; x is between (i) 1 and 2n+2 or (ii) less than 1 for fuels such as coal, coal tar, pyrolysis fuel oils, and the like; and y is between 0 and n. The hydrocarbon feedstock may include, for example, simple hydrocarbons (e.g., methane, ethane, propane, butane, etc.), aromatic feedstocks (e.g., benzene, toluene, xylene, methyl naphthalene, pyrolysis fuel oil, coal tar, coal, heavy oil, oil, bio-oil, bio-diesel, other biologically derived hydrocarbons, and the like), unsaturated hydrocarbons (e.g., ethylene, acetylene, butadiene, styrene, and the like), oxygenated hydrocarbons (e.g., ethanol, methanol, propanol, phenol, ketones, ethers, esters, and the like), or any combination thereof. These examples are provided as non-limiting examples of acceptable hydrocarbon feedstocks which may further be combined or mixed with other components for manufacture. A hydrocarbon feedstock may refer to a feedstock in which the majority of the feedstock (e.g., more than about 50% by weight) is hydrocarbon in nature. The reactive hydrocarbon feedstock may comprise at least about 70% by weight methane, ethane, propane or mixtures thereof. The hydrocarbon feedstock may comprise or be natural gas. The hydrocarbon may comprise or be methane, ethane, propane or mixtures thereof. The hydrocarbon may comprise methane, ethane, propane, butane, acetylene, ethylene, carbon black oil, coal tar, crude coal tar, diesel oil, benzene or methyl naphthalene. The hydrocarbon may comprise (e.g., additional) polycyclic aromatic hydrocarbons. The hydrocarbon feedstock may comprise one or more simple hydrocarbons, one or more aromatic feedstocks, one or more unsaturated hydrocarbons, one or more oxygenated hydrocarbons, or any combination thereof. The hydrocarbon feedstock may comprise, for example, methane, ethane, propane, butane, pentane, natural gas, benzene, toluene, xylene, ethylbenzene, naphthalene, methyl naphthalene, dimethyl naphthalene, anthracene, methyl anthracene, other monocyclic or polycyclic aromatic hydrocarbons, carbon black oil, diesel oil, pyrolysis fuel oil, coal tar, crude coal tar, coal, heavy oil, oil, bio-oil, bio-diesel, other biologically derived hydrocarbons, ethylene, acetylene, propylene, butadiene, styrene, ethanol, methanol, propanol, phenol, one or more ketones, one or more ethers, one or more esters, one or more aldehydes, or any combination thereof. The feedstock may comprise one or more derivatives of feedstock compounds described herein, such as, for example, benzene or its derivative(s), naphthalene or its derivative(s), anthracene or its derivative(s), etc. The hydrocarbon feedstock (also “feedstock” herein) may comprise a given feedstock (e.g., among the aforementioned feedstocks) at a concentration (e.g., in a mixture of feedstocks) greater than or equal to about 1 ppm, 5 ppm, 10 ppm, 25 ppm, 50 ppm, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.50%, 1.6%, 1.7%, 1.8%, 1.9%, 2%, 2.50%, 3%, 3.50%, 4%, 4.50%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 55%, 60%, 65%, 70%, 75%, 80%, 85%, 90%, 95% or 99% by weight, volume or mole. Alternatively, or in addition, the feedstock may comprise the given feedstock at a concentration (e.g., in a mixture of feedstocks) less than or equal to about 100% 99%, 95%, 90%, 85%, 80%, 75%, 70%, 65%, 60%, 55%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 110%, 10%, 9%, 80%, 7%, 6%, 5%, 4.5%, 4%, 3.5%, 3%, 2.5%, 2%, 1.9%, 1.8%, 1.7%, 1.6%, 1.5%, 1.4%, 1.3%, 1.2%, 1.1%, 1%, 0.9%, 0.8%, 0.7%, 0.6%, 0.5%, 0.4%, 0.3%, 0.2%, 0.1%, 0.05%, 0.01%, 50 ppm, 25 ppm, 10 ppm, 5 ppm or 1 ppm by weight, volume or mole. The feedstock may comprise additional feedstocks (e.g., in a mixture of feedstocks) at similar or different concentrations. Such additional feedstocks may be selected, for example, among the aforementioned feedstocks not selected as the given feedstock. The given feedstock may itself comprise a mixture (e.g., such as natural gas).

The hydrocarbon feedstock may be provided to the system at a rate of, for example, greater than or equal to about 50 grams per hour (g/hr), 100 g/hr, 250 g/hr, 500 g/hr, 750 g/hr, 1 kilogram per hour (kg/hr), 2 kg/hr, 5 kg/hr, 10 kg/hr, 15 kg/hr, 20 kg/hr, 25 kg/hr, 30 kg/hr, 35 kg/hr, 40 kg/hr, 45 kg/hr, 50 kg/hr, 55 kg/hr, 60 kg/hr, 65 kg/hr, 70 kg/hr, 75 kg/hr, 80 kg/hr, 85 kg/hr, 90 kg/hr, 95 kg/hr, 100 kg/hr, 150 kg/hr, 200 kg/hr, 250 kg/hr, 300 kg/hr, 350 kg/hr, 400 kg/hr, 450 kg/hr, 500 kg/hr, 600 kg/hr, 700 kg/hr, 800 kg/hr, 900 kg/hr, 1,000 kg/hr, 1,100 kg/hr, 1,200 kg/hr, 1,300 kg/hr, 1,400 kg/hr, 1,500 kg/hr, 1,600 kg/hr, 1,700 kg/hr, 1,800 kg/hr, 1,900 kg/hr, 2,000 kg/hr, 2,100 kg/hr, 2,200 kg/hr, 2,300 kg/hr, 2,400 kg/hr, 2,500 kg/hr, 3,000 kg/hr, 3,500 kg/hr, 4,000 kg/hr, 4,500 kg/hr, 5,000 kg/hr, 6,000 kg/hr, 7,000 kg/hr, 8,000 kg/hr, 9,000 kg/hr or 10,000 kg/hr. Alternatively, or in addition, the feedstock (e.g., hydrocarbon) may be provided to the system (e.g., to the reactor) at a rate of, for example, less than or equal to about 10,000 kg/hr, 9,000 kg/hr, 8,000 kg/hr, 7,000 kg/hr, 6,000 kg/hr, 5,000 kg/hr, 4,500 kg/hr, 4,000 kg/hr, 3,500 kg/hr, 3,000 kg/hr, 2,500 kg/hr, 2,400 kg/hr, 2,300 kg/hr, 2,200 kg/hr, 2,100 kg/hr, 2,000 kg/hr, 1,900 kg/hr, 1,800 kg/hr, 1,700 kg/hr, 1,600 kg/hr, 1,500 kg/hr, 1,400 kg/hr, 1,300 kg/hr, 1,200 kg/hr, 1,100 kg/hr, 1,000 kg/hr, 900 kg/hr, 800 kg/hr, 700 kg/hr, 600 kg/hr, 500 kg/hr, 450 kg/hr, 400 kg/hr, 350 kg/hr, 300 kg/hr, 250 kg/hr, 200 kg/hr, 150 kg/hr, 100 kg/hr, 95 kg/hr, 90 kg/hr, 85 kg/hr, 80 kg/hr, 75 kg/hr, 70 kg/hr, 65 kg/hr, 60 kg/hr, 55 kg/hr, 50 kg/hr, 45 kg/hr, 40 kg/hr, 35 kg/hr, 30 kg/hr, 25 kg/hr, 20 kg/hr, 15 kg/hr, 10 kg/hr, 5 kg/hr, 2 kg/hr, 1 kg/hr, 750 g/hr, 500 g/hr, 250 g/hr or 100 g/hr.

The non-hydrogenous gas may be provided to the reactor in presence of the plasma and in absence of the hydrocarbon feedstock for a time period sufficient for the reactor to reach thermal steady state. The flow rate of the non-hydrogenous gas to reach steady state may be equal to or substantially equal to the flow rate during generation of the carbon particles and effluent gas. Alternatively, a first flow rate may be used during reactor heating and the flow rate may be adjusted or modified during carbon particle generation. In an example, the flow rate of non-hydrogenous gas during heating may be greater than the flow rate of non-hydrogenous gas during carbon particle production. In another example, the flow rate of the non-hydrogenous gas during heating may be less than the flow rate of the non-hydrogenous gas during carbon particle production. The flow rate of the non-hydrogenous gas may be as described elsewhere herein. The time period to reach thermal steady state may depend on reactor size, flow rate of the non-hydrogenous gas, power provided to the plasma generating electrodes. The time period may be less than or equal to about 10 hours (hr), 8 hr, 6 hr, 5 hr, 4 hr, 3 hr, 2 hr, 1 hr, or less. The time period may be greater than or equal to about 1 hr, 2 hr, 3 hr, 4 hr, 5 hr, 6 hr, 8 hr, 10 hr, or more.

The method may further include providing a startup gas. The startup gas may be provided to the reactor after the reactor has reached thermal steady state or quasi-thermal steady state. The startup gas may be provided to initiate the feedstock pyrolysis reaction. The startup gas may be provided to initiate pyrolysis. The startup gas may comprise at least about 50 mol %, 60 mol %, 70 mol %, 80 mol %, 90 mol %, or more hydrogen. In an example, the startup gas may comprise pure or substantially pure hydrogen gas. In another example, the startup gas may comprise greater than or equal to about 80 mol % hydrogen. The non-hydrogenous gas, or mixture thereof, may be provided once the pyrolysis reaction has been initiated.

The non-hydrogenous gas may be provided to the reactor by a gas supply system. The non-hydrogenous gas may be the plasma gas. The non-hydrogenous gas may include nitrogen, helium, neon, krypton, argon, carbon monoxide, carbon dioxide, or any combination thereof. The non-hydrogenous gas may be a pure gas. Alternatively, the non-hydrogenous gas may comprise a mixture of gases. As shown in FIG. 1, the system may comprise multiple mass flowmeters. One mass flowmeter may be used for each different type of gas used to control flow and mixing, if using a mixed non-hydrogenous gas, of the gases. The example process of FIG. 1 may include a recirculation loop configured to recycle components of the effluent gas back to the reactor. In an industrial process, such a recirculation loop may be configured to recycle components of the effluent gas back to the reactor which may increase efficiency and conversion yields of the feedstock.

The non-hydrogenous gas, separated gas, hydrogen, or any combination thereof may be provided to the system at a rate of, for example, greater than or equal to about 0 normal cubic meter/hour (Nm³/hr), 0.1 Nm³/hr, 0.2 Nm³/hr, 0.5 Nm³/hr, 1 Nm³/hr, 1.5 Nm³/hr, 2 Nm³/hr, 5 Nm³/hr, 10 Nm³/hr, 25 Nm³/hr, 50 Nm³/hr, 75 Nm³/hr, 100 Nm³/hr, 150 Nm³/hr, 200 Nm³/hr, 250 Nm³/hr, 300 Nm³/hr, 350 Nm³/hr, 400 Nm³/hr, 450 Nm³/hr, 500 Nm³/hr, 550 Nm³/hr, 600 Nm³/hr, 650 Nm³/hr, 700 Nm³/hr, 750 Nm³/hr, 800 Nm³/hr, 850 Nm³/hr, 900 Nm³/hr, 950 Nm³/hr, 1,000 Nm³/hr, 2,000 Nm³/hr, 3,000 Nm³/hr, 4,000 Nm³/hr, 5,000 Nm³/hr, 6,000 Nm³/hr, 7,000 Nm³/hr, 8,000 Nm³/hr, 9,000 Nm³/hr, 10,000 Nm³/hr, 12,000 Nm³/hr, 14,000 Nm³/hr, 16,000 Nm³/hr, 18,000 Nm³/hr, 20,000 Nm³/hr, 30,000 Nm³/hr, 40,000 Nm³/hr, 50,000 Nm³/hr, 60,000 Nm³/hr, 70,000 Nm³/hr, 80,000 Nm³/hr, 90,000 Nm³/hr or 15,000 Nm³/hr. Alternatively, or in addition, a given gas or a sum of a subset or of all process gases may be provided to the system (e.g., to the reactor) at a rate of, for example, less than or equal to about 100,000 Nm³/hr, 90,000 Nm³/hr, 80,000 Nm³/hr, 70,000 Nm³/hr, 60,000 Nm³/hr, 50,000 Nm³/hr, 40,000 Nm³/hr, 30,000 Nm³/hr, 20,000 Nm³/hr, 18,000 Nm³/hr, 16,000 Nm³/hr, 14,000 Nm³/hr, 12,000 Nm³/hr, 10,000 Nm³/hr, 9,000 Nm³/hr, 8,000 Nm³/hr, 7,000 Nm³/hr, 6,000 Nm³/hr, 5,000 Nm³/hr, 4,000 Nm³/hr, 3,000 Nm³/hr, 2,000 Nm³/hr, 1,000 Nm³/hr, 950 Nm³/hr, 900 Nm³/hr, 850 Nm³/hr, 800 Nm³/hr, 750 Nm³/hr, 700 Nm³/hr, 650 Nm³/hr, 600 Nm³/hr, 550 Nm³/hr, 500 Nm³/hr, 450 Nm³/hr, 400 Nm³/hr, 350 Nm³/hr, 300 Nm³/hr, 250 Nm³/hr, 200 Nm³/hr, 150 Nm³/hr, 100 Nm³/hr, 75 Nm³/hr, 50 Nm³/hr, 25 Nm³/hr, 10 Nm³/hr, 5 Nm³/hr, 2 Nm³/hr, 1.5 Nm³/hr, 1 Nm³/hr, 0.5 Nm³/hr or 0.2 Nm³/hr. The non-hydrogenous gas, separated gas, hydrogen, or mixture thereof may be provided to the system at ratio of, for example, at greater than or equal to about 0, 0.0005, 0.001, 0.002, 0.005, 0.1, 0.2, 0.5, 1, 2, 3, 4, 5, 6, 7, 8, 9, 10, 15, 20, 25, 30, 35, 40, 45, 50, 75 or 90 moles of process gas(es) per mole of feedstock. Alternatively, or in addition, the non-hydrogenous gas, separated gas, hydrogen, or mixture thereof may be provided to the system at ratio of, for example, less than or equal to about 100, 90, 75, 50, 45, 40, 35, 30, 25, 20, 15, 10, 9, 8, 7, 6, 5, 4, 3, 2, 1, 0.5, 0.2, 0.1, 0.005, 0.002, 0.001 or 0.0005 moles of process gas(es) per mole of feedstock. Less than or equal to about 100%, 75%, 50%, 40%, 30%, 20%, 10%, 5% or 1% of the process gas(es) provided to the system may be heated with electrical energy. Alternatively, or in addition, greater than or equal to about 0%, 1%, 5%, 10%, 20%, 30%, 40%, 50% or 75% of the process gas(es) provided to the system may be heated with electrical energy.

The non-hydrogenous gas, separated gas, hydrogen, or other gas (e.g., the feedstock alone or in combination with at least one process gas) may be heated at a given pressure. The feedstock (e.g., alone or in combination with at least one process gas) may react at the given pressure (also “reaction pressure” herein). The heating and reaction may be implemented in a reactor at the given pressure (also “reactor pressure” herein). The pressure may be, for example, greater than or equal to about 0 bar, 0.5 bar, 1 bar, 1.1 bar, 1.2 bar, 1.3 bar, 1.4 bar, 1.5 bar, 1.6 bar, 1.7 bar, 1.8 bar, 1.9 bar, 2 bar, 2.1 bar, 2.2 bar, 2.3 bar, 2.4 bar, 2.5 bar, 2.6 bar, 2.7 bar, 2.8 bar, 2.9 bar, 3 bar, 3.1 bar, 3.2 bar, 3.3 bar, 3.4 bar, 3.5 bar, 3.6 bar, 3.7 bar, 3.8 bar, 3.9 bar, 4 bar, 4.5 bar, 5 bar, 6 bar, 7 bar, 8 bar, 9 bar, 10 bar, 11 bar, 12 bar, 13 bar, 14 bar, 15 bar, 16 bar, 17 bar, 18 bar, 19 bar, 20 bar, 21 bar, 22 bar, 23 bar, 24 bar, 25 bar, 26 bar, 27 bar, 28 bar, 29 bar, 30 bar, 35 bar, 40 bar, 45 bar, 50 bar, 55 bar, 60 bar, 65 bar, 70 bar, 75 bar, or more. Alternatively, or in addition, the pressure may be, for example, less than or equal to about 100 bar, 90 bar, 80 bar, 75 bar, 70 bar, 65 bar, 60 bar, 55 bar, 50 bar, 45 bar, 40 bar, 35 bar, 30 bar, 29 bar, 28 bar, 27 bar, 26 bar, 25 bar, 24 bar, 23 bar, 22 bar, 21 bar, 20 bar, 19 bar, 18 bar, 17 bar, 16 bar, 15 bar, 14 bar, 13 bar, 12 bar, 11 bar, 10 bar, 9 bar, 8 bar, 7 bar, 6 bar, 5 bar, 4 bar, 3.9 bar, 3.8 bar, 3.7 bar, 3.6 bar, 3.5 bar, 3.4 bar, 3.3 bar, 3.2 bar, 3.1 bar, 3 bar, 2.9 bar, 2.8 bar, 2.7 bar, 2.6 bar, 2.5 bar, 2.4 bar, 2.3 bar, 2.2 bar, 2.1 bar, 2 bar, 1.9 bar, 1.8 bar, 1.7 bar, 1.6 bar, 1.5 bar, 1.4 bar, 1.3 bar, 1.2 bar, 1.1 bar, or less. The pressure may be greater than atmospheric pressure (above atmospheric pressures). The pressure may be from about 1.5 bar to about 25 bar. The pressure may be from about 1 bar to about 70 bar. The pressure may be from about 5 bar to about 25 bar. The pressure may be from about 10 bar to about 20 bar. The pressure may be from about 5 bar to about 15 bar. The pressure may be greater than or equal to about 2 bar. The pressure may be greater than or equal to about 5 bar. The pressure may be greater than or equal to about 10 bar. The feedstock or the process gas(es) may be provided to the reactor at a suitable pressure (e.g., at least about 0.01%, 0.05%, 0.1%, 0.5%, 1%, 2%, 5%, 10%, 15%, 20%, 25% or 50% above reactor pressure, which pressure may depend on mode of injection, such as, for example, a higher pressure through an injector than through an inlet port). The feedstock or a process gas may be provided to the reactor, for example, at its respective delivery or storage (e.g., cylinder or container) pressure. The feedstock or a process may or may not be (e.g., additionally) compressed before it is provided to the reactor. The incoming feedstock may be provided at a pressure in a range as defined by any two of the proceeding pressure values. For example, the feedstock can be provided at a pressure of about 30 to about 35 bar, and can be metered down to a pressure of about 5 to about 15 bar. There may be a pressure drop across the reactor. For example, an inlet pressure of the reactor and an outlet pressure of the reactor may be different. The outlet pressure of the reactor may be a value selected from the proceeding list that is less than an inlet pressure selected from the proceeding list. For example, a reactor with an about 15 bar inlet pressure can have an about 14 bar outlet pressure. In another example, the inlet pressure can be about 4 bar and the outlet pressure can be about 2 bar. In another example, the inlet pressure can be about 35 bar and the outlet pressure can be about 30 bar. The pressure drop across the reactor can aid in the movement of gases or carbon particles through the reactor.

The one or more gases (e.g., the feedstock alone or in combination with at least one process gas (e.g., non-hydrogenous gas, hydrogen, etc.)) may be subjected to (e.g., exposed to) a reactor temperature of, for example, greater than or equal to about 1,000° C., 1,100° C., 1,200° C., 1,300° C., 1,400° C., 1,500° C., 1,600° C., 1,700° C., 1,800° C., 1,900° C., 2,000° C., 2050° C., 2,100° C., 2,150° C., 2,200° C., 2,250° C., 2,300° C., 2,350° C., 2,400° C., 2,450° C., 2,500° C., 2,550° C., 2,600° C., 2,650° C., 2,700° C., 2,750° C., 2,800° C., 2,850° C., 2,900° C., 2,950° C., 3,000° C., 3,050° C., 3,100° C., 3,150° C., 3,200° C., 3,250° C., 3,300° C., 3,350° C., 3,400° C. or 3,450° C. Alternatively, or in addition, the one or more gases (e.g., the feedstock alone or in combination with at least one process gas) may be heated to or the feedstock may be subjected to (e.g., exposed to) a reactor temperature of, for example, less than or equal to about 3,500° C., 3,450° C., 3,400° C., 3,350° C., 3,300° C., 3,250° C., 3,200° C., 3,150° C., 3,100° C., 3,050° C., 3,000° C., 2,950° C., 2,900° C., 2,850° C., 2,800° C., 2,750° C., 2,700° C., 2,650° C., 2,600° C., 2,550° C., 2,500° C., 2,450° C., 2,400° C., 2,350° C., 2,300° C., 2,250° C., 2,200° C., 2,150° C., 2,100° C., 2050° C., 2,000° C., 1,900° C., 1,800° C., 1,700° C., 1,600° C., 1,500° C., 1,400° C., 1,300° C., 1,200° C. or 1,100° C. In an example, the non-hydrogenous gas may be contacted with the hydrocarbon feedstock at a temperature of no more than about 1900° C. In another example, the non-hydrogenous gas may be contacted with the hydrocarbon feedstock at a temperature of no more than 1800° C. In another example, the separated gas and may be contacted with the additional hydrocarbon feedstock at a temperature of no more than about 1900° C. In another example, the separated gas and may be contacted with the additional hydrocarbon feedstock at a temperature of no more than about 1800° C. Lowering the amount of hydrogen in the system may permit lower reaction temperatures to achieve similar yields as a higher reactor temperature with a hydrogen plasma gas.

The use of a non-hydrogenous gas as part or all of the plasma gas may permit pyrolysis of the hydrocarbon feedstock at lower temperatures, which in turn may reduce equipment wear (e.g., electrode and reactor wear), may reduce energy input, may reduce fouling, and may provide enhanced carbon particle tuning as compared to systems using hydrogen alone or predominantly hydrogen as the plasma gas. The lower reaction temperature may also permit formation of particles with lower Lc and may alter the elemental composition (e.g., Carbon to Hydrogen ratio) as well as surface activity, types of chemical functional groups bound to the surface and other surface properties which may alter and improve rubber reinforcing capabilities of the particles.

Conversion of hydrocarbon feedstock to carbon and hydrogen may be a factor in the economic viability of industrial hydrocarbon pyrolysis processes. Increasing feedstock conversion may be achieved via increasing reaction time, reaction temperature, or both. Increasing reaction time may result in using a larger reactor which may add to manufacturing costs of the reactor and decrease the efficiency of reactor insulation, potentially leading to higher operating costs. Increasing temperature may use additional power which may increase manufacturing costs. Reducing temperature and increasing conversion through the use of a reduced concentration of hydrogen may lower manufacturing costs of carbon particles and hydrogen generated in hydrocarbon pyrolysis processes. The amount of hydrogen in the reactor may be reduced by removal of generated hydrogen from the reactor. Generated hydrogen may be removed with the effluent gas. To reduce reactor hydrogen concentration, in examples that use recycled effluent gas, the hydrogen may be separated from the higher molecular weight species. The separated hydrogen may not be returned to the reactor. Alternatively, a reduced amount of hydrogen may be returned to the reactor.

The non-hydrogenous gas may be provided to the reactor as a pure or substantially pure non-hydrogenous gas (e.g., any gas or mixture of gas that does not include hydrogen). Alternatively, the non-hydrogenous gas may be mixed with or injected in tandem with hydrogen. In an example, non-hydrogenous and hydrogen gas are provided to the reactor in tandem. The ratio of non-hydrogen gas to hydrogen provided to the reactor may be at least about 2 to 1, 4 to 1, 6 to 1, 8 to 1, 10 to 1, 15 to 1, 20 to 1, 25 to 1, 30 to 1, 40 to 1, or greater. In an example, the ratio of non-hydrogen gas to hydrogen provided to the reactor may be at least about 4 to 1. In another example the ratio of non-hydrogen gas to hydrogen provided to the reactor may be at least about 10 to 1. The non-hydrogen and hydrogen gas provided to the reactor may be provided from and external gas supply, from the effluent stream, or both. The effluent stream may be separated into hydrogen and high molecular weight species (e.g., non-hydrogenous gas)). The high molecular weight species, hydrogen, or both may be recycled or otherwise returned to the reactor. The amount of hydrogen in the return stream may be less than or equal to about 100 mole percent (mol %), 90 mol %, 80 mol %, 70 mol %, 60 mol %, 50 ml %, 40 mol %, 30 mol %, 25 mol %, 20 mol %, 15 mol %, 10 mol %, 5 mol %, or less. In an example, the return stream (e.g., separated gas) may comprise less than or equal to about 50 mol % hydrogen. In another example, the return stream (e.g., separated gas) may comprise less than or equal to about 25 mol % hydrogen. In another example, the return stream (e.g., separated gas) may comprise less than or equal to about 5 mol % hydrogen.

Hydrocarbon feedstock may be injected into the reactor in tandem with the non-hydrogenous gas or downstream of the non-hydrogenous gas. In an example, the hydrocarbon feedstock is injected into the reactor downstream of the non-hydrogenous gas. The hydrocarbon feedstock may be injected directly into the non-hydrogenous gas. Injection of the hydrocarbon feedstock into the heated non-hydrogenous gas may initiate the pyrolysis process to convert the hydrocarbon feedstock into solid carbon and hydrogen.

Carbon particle characteristics may be tuned or otherwise controlled by modification and tuning of the molecular weight and composition of the gases delivered to the pyrolysis reactor (e.g., hydrocarbon feedstock, hydrogen, non-hydrogenous gases). Additionally, controlling the molecular weight and composition of the delivered gases may increase the capability of producing broader ranges of carbon black nanostructures and improve product yields. The molecular weight or composition of the delivered gas may be controlled or otherwise tuned by separating or purifying the effluent gas and returning select components to the reactor either with or without an externally supplied gas. The resultant delivered gas (e.g., plasma gas) may have an average molecular weigh and composition. In an example, the system and method may include recycling at least a portion of the effluent gas back to the reactor. The recycle stream may include at least one gas from the effluent stream. Alternatively, or in addition to, the recycle stream may include a mixture of gases from the recycle stream. The returned gas from the recycle stream may comprise predominantly high molecular weight species to increase the average molecular weight of the gas (e.g., plasma gas) delivered to the reactor. High molecular weight species may include nitrogen, helium, neon, krypton, argon, carbon monoxide, carbon dioxide, water methane, ethane, ethylene, or any combination thereof. The high molecular weight species may not include hydrogen. The molecular weight of the delivered gas may be controlled by blending or mixing high molecular weight species with hydrogen prior to delivery to the reactor. Recycling effluent gas back to the reactor may reduce production costs and increase the efficiency of material use. Supplying external gases to the reactor may allow for direct control over gas composition and may reduce costs and material usage efficiencies.

Increasing the average molecular weight of the plasma gas (e.g., reaction gas) may reduce the hydrogen concentration in the gas phase in the reactor. Reduction of hydrogen concentration in a gas phase hydrocarbon pyrolysis reaction can increase surface area and structure of carbon black particles produced and can reduce reactor fouling, improve feedstock conversion, and reduce wear on graphite components. A range of example process conditions is described where reduction in the hydrogen concentration of the reacting gas can achieve the affects listed above.

The average molecular weight of the delivered gas (e.g., gas used to generate the plasma or plasma gas) may be at least about 1 kilogram per kilomole (kg/kmol), 1.5 kg/kmol, 2 kg/kmol, 3 kg/kmol, 4 kg/kmol, 5 kg/kmol, 10 kg/kmol, 15 kg/kmol, 20 kg/kmol, 25 kg/kmol, 30 kg/kmol, 40 kg/kmol, 50 kg/kmol, 60 kg/kmol, 70 kg/kmol, 80 kg/kmol, 90 kg/kmol, or more. The average molecular weight of the delivered gas may be less than or equal to about 90 kg/kmol, 80 kg/kmol, 70 kg/kmol, 60 kg/kmol, 50 kg/kmol, 40 kg/kmol, 30 kg/kmol, 25 kg/kmol, 20 kg/kmol, 15 kg/kmol, 10 kg/kmol, 5 kg/kmol, 4 kg/kmol, 3 kg/kmol, 2 kg/kmol, 1.5 kg/kmol, 1 kg/kmol, or less. The average molecular weight of the delivered species may be from about 1 kg/kmol to 1.5 kg/kmol, 1 kg/kmol to 2 kg/kmol, 1 kg/kmol to 3 kg/kmol, 1 kg/kmol to 4 kg/kmol, 1 kg/kmol to 5 kg/kmol, 1 kg/kmol to 10 kg/kmol, 1 kg/kmol to 15 kg/kmol, 1 kg/kmol to 20 kg/kmol, 1 kg/kmol to 25 kg/kmol, 1 kg/kmol to 30 kg/kmol, 1 kg/kmol to 40 kg/kmol, 1 kg/kmol to 50 kg/kmol, 1 kg/kmol to 60 kg/kmol, 1 kg/kmol to 70 kg/kmol, 1 kg/kmol to 80 kg/kmol, 1 kg/kmol to 90 kg/kmol, 1.5 kg/kmol to 2 kg/kmol, 1.5 kg/kmol to 3 kg/kmol, 1.5 kg/kmol to 4 kg/kmol, 1.5 kg/kmol to 5 kg/kmol, 1.5 kg/kmol to 10 kg/kmol, 1.5 kg/kmol to 15 kg/kmol, 1.5 kg/kmol to 20 kg/kmol, 1.5 kg/kmol to 25 kg/kmol, 1.5 kg/kmol to 30 kg/kmol, 1.5 kg/kmol to 40 kg/kmol, 1.5 kg/kmol to 50 kg/kmol, 1.5 kg/kmol to 60 kg/kmol, 1.5 kg/kmol to 70 kg/kmol, 1.5 kg/kmol to 80 kg/kmol, 1.5 kg/kmol to 90 kg/kmol, 2 kg/kmol to 3 kg/kmol, 2 kg/kmol to 4 kg/kmol, 2 kg/kmol to 5 kg/kmol, 2 kg/kmol to 10 kg/kmol, 2 kg/kmol to 15 kg/kmol, 2 kg/kmol to 20 kg/kmol, 2 kg/kmol to 25 kg/kmol, 2 kg/kmol to 30 kg/kmol, 2 kg/kmol to 40 kg/kmol, 2 kg/kmol to 50 kg/kmol, 2 kg/kmol to 60 kg/kmol, 2 kg/kmol to 70 kg/kmol, 2 kg/kmol to 80 kg/kmol, 2 kg/kmol to 90 kg/kmol, 3 kg/kmol to 4 kg/kmol, 3 kg/kmol to 5 kg/kmol, 3 kg/kmol to 10 kg/kmol, 3 kg/kmol to 15 kg/kmol, 3 kg/kmol to 20 kg/kmol, 3 kg/kmol to 25 kg/kmol, 3 kg/kmol to 30 kg/kmol, 3 kg/kmol to 40 kg/kmol, 3 kg/kmol to 50 kg/kmol, 3 kg/kmol to 60 kg/kmol, 3 kg/kmol to 70 kg/kmol, 3 kg/kmol to 80 kg/kmol, 3 kg/kmol to 90 kg/kmol, 4 kg/kmol to 5 kg/kmol, 4 kg/kmol to 10 kg/kmol, 4 kg/kmol to 15 kg/kmol, 4 kg/kmol to 20 kg/kmol, 4 kg/kmol to 25 kg/kmol, 4 kg/kmol to 30 kg/kmol, 4 kg/kmol to 40 kg/kmol, 4 kg/kmol to 50 kg/kmol, 4 kg/kmol to 60 kg/kmol, 4 kg/kmol to 70 kg/kmol, 4 kg/kmol to 80 kg/kmol, 4 kg/kmol to 90 kg/kmol, 5 kg/kmol to 10 kg/kmol, 5 kg/kmol to 15 kg/kmol, 5 kg/kmol to 20 kg/kmol, 5 kg/kmol to 25 kg/kmol, 5 kg/kmol to 30 kg/kmol, 5 kg/kmol to 40 kg/kmol, 5 kg/kmol to 50 kg/kmol, 5 kg/kmol to 60 kg/kmol, 5 kg/kmol to 70 kg/kmol, 5 kg/kmol to 80 kg/kmol, 5 kg/kmol to 90 kg/kmol, 10 kg/kmol to 15 kg/kmol, 10 kg/kmol to 20 kg/kmol, 10 kg/kmol to 25 kg/kmol, 10 kg/kmol to 30 kg/kmol, 10 kg/kmol to 40 kg/kmol, 10 kg/kmol to 50 kg/kmol, 10 kg/kmol to 60 kg/kmol, 10 kg/kmol to 70 kg/kmol, 10 kg/kmol to 80 kg/kmol, 10 kg/kmol to 90 kg/kmol, 20 kg/kmol to 25 kg/kmol, 20 kg/kmol to 30 kg/kmol, 20 kg/kmol to 40 kg/kmol, 20 kg/kmol to 50 kg/kmol, 20 kg/kmol to 60 kg/kmol, 20 kg/kmol to 70 kg/kmol, 20 kg/kmol to 80 kg/kmol, 20 kg/kmol to 90 kg/kmol, 25 kg/kmol to 30 kg/kmol, 25 kg/kmol to 40 kg/kmol, 25 kg/kmol to 50 kg/kmol, 25 kg/kmol to 60 kg/kmol, 25 kg/kmol to 70 kg/kmol, 25 kg/kmol to 80 kg/kmol, 25 kg/kmol to 90 kg/kmol, 30 kg/kmol to 40 kg/kmol, 30 kg/kmol to 50 kg/kmol, 30 kg/kmol to 60 kg/kmol, 30 kg/kmol to 70 kg/kmol, 30 kg/kmol to 80 kg/kmol, 30 kg/kmol to 90 kg/kmol, 40 kg/kmol to 50 kg/kmol, 40 kg/kmol to 60 kg/kmol, 40 kg/kmol to 70 kg/kmol, 40 kg/kmol to 80 kg/kmol, 40 kg/kmol to 90 kg/kmol, 50 kg/kmol to 60 kg/kmol, 50 kg/kmol to 70 kg/kmol, 50 kg/kmol to 80 kg/kmol, 50 kg/kmol to 90 kg/kmol, 60 kg/kmol to 70 kg/kmol, 60 kg/kmol to 80 kg/kmol, 60 kg/kmol to 90 kg/kmol, 70 kg/kmol to 80 kg/kmol, 70 kg/kmol to 90 kg/kmol, or 80 kg/kmol to 90 kg/kmol.

The effluent gas may be returned directly to the reactor, upstream of the reactor at the plasma chamber, upstream or downstream of the electrode bodies, or any combination thereof. Alternatively, or in addition to, the effluent gas may be separated into one or more gas streams. One of the one or more gas streams may comprise non-hydrogenous species (e.g., high molecular weight species) and another of the one or more gas streams may comprise hydrogen. The components of the effluent gas may be separated as described elsewhere herein. The gas composition of the recycle stream may comprised gas derived from the effluent stream, an externally supplied gas, or any combination thereof. In an example, the effluent gas is separated into hydrogen and non-hydrogenous species. After separation, the hydrogen or non-hydrogenous gases may be further processed (e.g., compressed, heated, cooled, purified, etc.) to generate derivative gases of the separated gas. The recycle stream may comprise the separated gas, one or more derivative gases, or any combination thereof. The recycle stream may include, but is not limited to, hydrogen, nitrogen, helium, neon, krypton, argon, carbon monoxide, carbon dioxide, water methane, ethane, ethylene, hydrogen cyanide, or any combination thereof.

The recycle stream may or may not be mixed with an external gas prior to being provided to the reactor. In an example, the recycle stream is not mixed with an external gas prior to being provided to the reactor. In another example, the recycle stream is mixed with an external gas prior to being provided to the reactor. The recycle stream may be mixed with an external gas stream such that the combined stream comprises at least about 5 mol %, 10 mol %, 15 mol %, 20 mol %, 25 mol %, 30 mol %, 40 mol %, 50 mol %, 60 mol %, 70 mol %, 80 mol %, 90 mol %, or more gas from the recycle stream. The recycle stream may be mixed with an external gas stream such that the combined stream comprises less than or equal to about 90 mol %, 80 mol %, 70 mol %, 60 mol %, 50 mol %, 40 mol %, 30 mol %, 25 mol %, 20 mol %, 15 mol %, 10 mol %, 5 mol %, or less gas from the recycle stream. The external gas may be any gas as described elsewhere herein, such as nitrogen, helium, neon, krypton, argon, carbon monoxide, carbon dioxide, or any combination thereof.

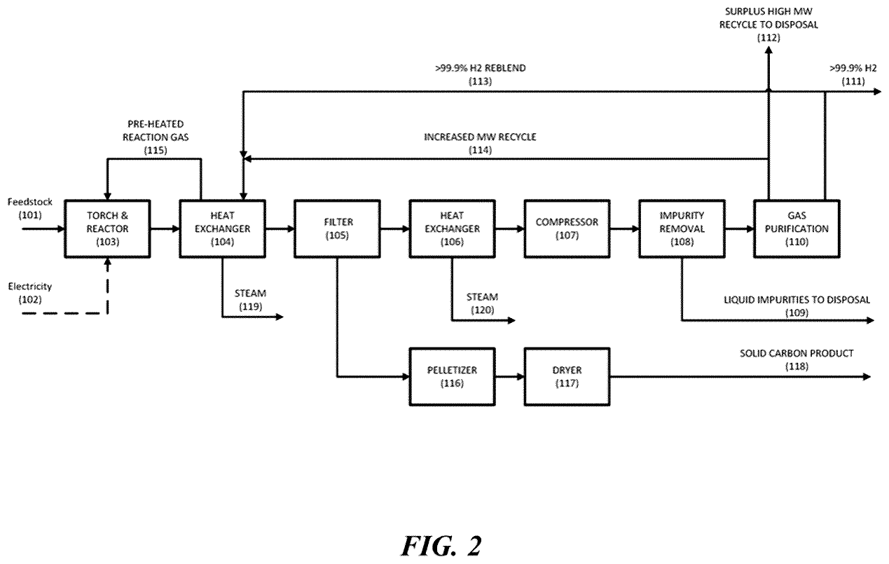

FIGS. 2-4 show example plasma pyrolysis processes that may be used to generate carbon particles and hydrogen. Modulation of the molecular weight and composition for the pre-heated reaction gases (e.g., plasma gas) stream (115, 215, 315) may impact the morphology of carbon nanostructures and yields within the plasma reactor (103, 203, 303). Controlling both the gas composition and molecular weight of this stream may expand the ability to create broader ranges of carbon nanostructures, increases yields, and reduces feedstock (101, 201, 301) costs.

Reaction products from plasma pyrolysis reactor (103, 203, 303) may be cooled and cross-exchanged in a heat exchange system (104, 204, 304) to produce steam (119, 219, 319) and provide pre-heat to the reaction gas (e.g., plasma gas) stream (115, 215, 315). The heat exchange system can be comprised of a series at least one or more gas to gas heat exchangers, boiler feedwater preheaters, saturated steam boilers, and superheaters. Solid phase reaction products may be separated from gas phase products at the main filter (105, 205, 305). Solid carbon products may be densified in a pelletizer (116, 216, 316) and then dried in a dryer (117, 217, 317) before leaving the process. The dryer can be a rotary dryer or a fluidized bed dryer. In addition to the pelletizer and dryer, there can be milling equipment for homogenization of carbon particle sizes.

Gaseous reaction products leaving filter (105, 205, 305) may be cooled in a heat exchanger (106, 206, 306) prior to compression from near atmospheric pressures to at least about 10 bar atmosphere (bara). Steam or pre-heated boiler feedwater (120, 220, 320) may be produced in this heat exchanger. Cooled reaction gases can then be increased in pressure to at least 10 bara in compressor (107, 207, 307). At elevated pressures, impurities in the gas stream may liquefy or pose a challenge for the purification equipment (110, 210, 310) thus an impurity removal system (108, 208, 308) may be used. The impurity removal system can be, and is not limited to, a cryogenic separator, a hydrolysis reactor and cooler, an adsorption/stripping column, a methanator, or any combination thereof. Liquid impurities can be removed and can either be collected as products or disposed of in a flare or thermal oxidizing unit.

Once any impurities that are unacceptable for purification unit (110) may be removed the remaining gas is separated yielding a >99.9% hydrogen stream (111,113) and an increased molecular weight stream (112,114). The gas purification unit can be and is not limited to a pressure swing adsorption unit, and/or membrane separation unit, and/or absorption/stripper separation unit, and/or cryogenic separation unit or any combination thereof.

FIG. 2 schematically illustrates an example process in which a controlled molecular weight and composition reaction gas stream is supplied to a pyrolysis reactor by purifying the gaseous products from the plasma pyrolysis reactor in absence of an external, non-feedstock gas source. The process may include providing a hydrocarbon feedstock (101) and a pre-heated reaction (e.g., plasma) gas (115). The hydrocarbon feedstock (101) and a pre-heated reaction (e.g., plasma) gas (115) may be thermally decomposed in a plasma pyrolysis reactor (103) supplied by electricity (102). The pre-heated reaction gas (115) from the process heat exchanger (104) can be supplied by the purification of gaseous products leaving the reaction vessel (103). Molecular weight composition of reaction gas can be controlled by modulating the flow of the increased molecular weight recycle stream (114) and the flow of the >99.9% hydrogen re-blend (113). Surplus 99.9% hydrogen (111) can leave the system for any downstream handling applications as a product and any surplus increased molecular weight recycle gases may be high molecular weight molecules. High molecular weight species may be recycled back into the reactor to generate solid carbon particles. In an example, the high molecular weight species not recycled back to the reactor may be disposed with a flare or thermal oxidizer.

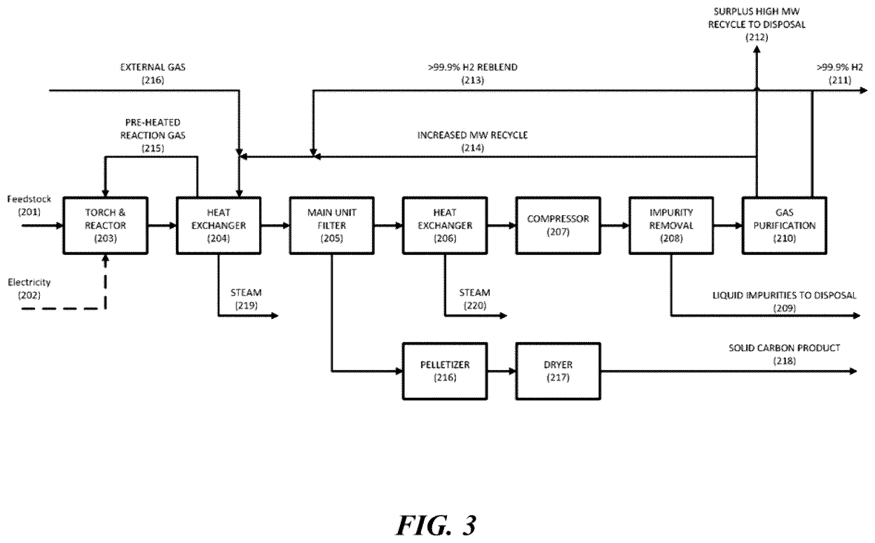

FIG. 3 schematically illustrates an example process in which a controlled molecular weight and composition reaction gas stream is supplied to a pyrolysis reactor partially by purifying the gaseous products from the plasma pyrolysis reactor and partially from an externally supplied gas. In this example, a portion of the pre-heated reaction gas (215) may be supplied by the gas purification system (210) via an increased molecular weight recycle stream (214) with hydrogen re-blend capability via >99.9% hydrogen re-blend stream (213), and a portion of the pre-heated reaction gas (215) supplied by external gases (216).

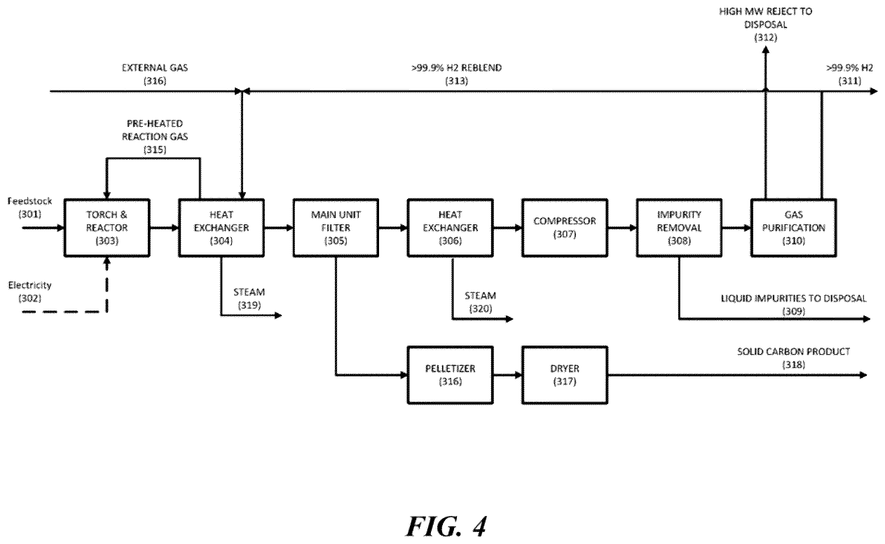

FIG. 4 schematically illustrates an example process in which a controlled molecular weight and composition reaction gas stream (e.g., plasma gas stream) is supplied to a pyrolysis reactor by an external gas stream. In this example, the pre-heated reaction gases (e.g., plasma gas) (315) supplied by an external source (316) with the capability to modulate molecular weight and composition via the >99.9% hydrogen re-blend stream (313).

The gas supply system may include valves (e.g., electronic or mechanical), pressure regulators, mass flow controllers, or any combination thereof. The valves, regulators, and flow controllers may be centrally managed, for example, by one or more computer controllers. The gas supply system may be configured to control or may control the flow of gas (e.g., plasma gas) or hydrocarbon feedstock into the reactor.

The flow rate of the plasma gas (e.g., non-hydrogenous gas, hydrogen gas, or both) and the hydrocarbon feedstock may be controlled or otherwise modulated to maintain a give dilution ratio. The dilution ratio (DR) may be calculated as shown in Equation 2.

$$DR = \frac{total moles of diluent gas}{total moles of carbon injected} \qquad ( 2 )$$

The diluent gas may comprise the non-hydrogenous gas, hydrogen, or other non-carbon containing gas. The dilution ratio may be less than or equal to about 10, 9, 8, 7, 6, 5, 4, 3, 2, 1, or less. The dilution ratio may be greater than or equal to about 1, 2, 3, 4, 5, 6, 7, 8, 9, 10, or more.

The hydrocarbon feedstock (e.g., methane) may be converted to carbon particles and hydrogen in presence of the plasma. Hydrocarbon feedstock conversion and total solids yield may be computed and estimated from measured flows and gas analysis instrumentation as described elsewhere herein. In an example, the hydrocarbon feedstock may comprise methane and methane conversion may be calculated as shown in Equation 3.

$${X}_{{CH}_{4}} = \frac{moles {CH}_{4} measured in process gas}{moles {CH}_{4} in feedstock} \qquad ( 3 )$$

Total solid yield may be estimated as shown in Equation 4.

$${X}_{solid yield} = \frac{total mass carbon measured in system}{mass carbon in {CH}_{4} feedstock} \qquad ( 4 )$$

Additionally, the hydrogen yield may be estimated as shown in Equation 5.

$${X}_{{H}_{2}} = \frac{moles {H}_{2} measured in process gas}{moles {H}_{2} in {CH}_{4} feedstock} \qquad ( 5 )$$

These above equations may be directed to methane. These equations may be modified to convert these calculations to other carbonaceous feedstocks or mixed carbonaceous feedstocks, such as methane and xylenes.

The reaction equilibrium of methane pyrolysis may be modulated by the relative concentration of hydrogen in the reactor. For example, following Le Chatelier's principle, reducing the concentration of hydrogen within the reactor may drive the reaction towards the product side and result in higher methane conversion and product yield. Hydrogen concentration may be reduced by using a non-hydrogenous dilution gas (e.g., for generating the plasma) or by removing product hydrogen from the system. By driving the reaction towards the generation of products via lowering hydrogen concentration the reactor may be operated at lower temperatures without reducing product yield or methane conversion. Additionally, the generated carbon particles may have similar or larger surface areas to particles generated in similar reactor systems using higher concentrations of hydrogen and higher temperatures. Returning the separated gas and providing additional hydrocarbon feedstock to the reactor may permit an increase in the conversion efficiency of the hydrocarbon feedstock. For example, returning the separated gas and providing additional hydrocarbon feedstock may increase the conversion efficiency of the hydrocarbon feedstock to greater than or equal to about 98%.

The process may have a feedstock conversion of greater than or equal to about 50%, 60%, 70%, 80%, 85%, 90%, 95%, 98%, or more. In an example, the feedstock conversion is greater than or equal to about 80%. In another example, the feedstock conversion is greater than or equal to about 90%. In another example, the feedstock conversion is greater than or equal to about 95%. The process may have a total solid yield of greater than or equal to about 50%, 60%, 70%, 80%, 85%, 90%, 95%, 98%, or more. In an example, the total solid yield is greater than or equal to about 80%. In another example, the total solid yield is greater than or equal to about 90%. In another example, the total solid yield is greater than or equal to about 95%. The process may have a hydrogen yield of greater than or equal to about 50%, 60%, 70%, 80%, 85%, 90%, 95%, 98%, or more. In an example, the hydrogen yield is greater than or equal to about 80%. In another example, the hydrogen yield is greater than or equal to about 90%. In another example, the hydrogen yield is greater than or equal to about 95%.

The impact of hydrogen concentration may be driven or otherwise influenced by particle nucleation and formation, chemical equilibrium dynamics, thermochemical gas attack, or any combination thereof. Hydrogen concentration may alter particle quality, conversion, and fouling based on the impact hydrogen concentration has on chemical kinetics of the mixture and the rates of various reactions. The process of forming solid carbon from a s pure hydrocarbon feedstock may involve a number of reversible reactions occurring continuously. At temperatures from about 1500° C. to 2100° C. using a methane feedstock, methane may lose hydrogen and add carbon to form acetylene. The acetylene may form aromatic rings which may grow into larger polyaromatic hydrocarbons (PAHs) that may grow into large planes of aromatic rings. The large planes of aromatic rings may combine and form a solid carbon nucleate. Throughout this process, many reactions may involve hydrocarbon molecules giving up hydrogens as the intermediate products move closer to generating pure carbon. As these reactions may be reversible, lower hydrogen content of the gas mixture may result in dehydrogenation occurring more quickly.

Hard carbon deposits (e.g., fouling) may be more likely to form when hydrocarbon gases contact the reactor walls than if solid carbon particles contact the walls. If the feedstock more quickly converts from hydrocarbon gases to solid particles, there may be less contact between the hydrocarbon gases and the wall, which may result in less fouling.

The decrease in hydrogen content may alter the surface area and structure of the product carbon may be due to the change in the rate of particle nucleation and growth. Surface area and structure may be a representation of individual ‘primary’ particles formed during the formation of the carbon black. In some cases, the lower percentages of hydrogen may increase the rate at which hydrocarbon feedstocks convert to solid carbon. As this rate increases, the rate at which new particles form may also increase. As new particles form faster, more carbon may be directed to forming new particles as opposed to adding onto existing particles. As a result, as hydrogen decreases, more new particles may be formed. More particles may lead to higher surface area and structure. Surface area and structure may be as described elsewhere herein. The carbon particles may have an aggregation structure, as measured by dibutyl phthalate (DBP) absorption, of at least about 100 milliliters per 100 grams of carbon black (mL/100 g). DBP absorption may be controlled or tuned by the addition of additives during pyrolysis of the hydrocarbon feedstock. Additives may be ionic compounds such as, for example, alkali metal salts. Alkali metal salts may include, but are not limited to, acetate, adipate, ascorbate, benzoate, bicarbonate, carbonate, citrate, dehydroacetate, erythorbate, ethyl para-hydropenzoate, formate, fumarate, gluconate, hydrogen acetate, hydroxide, lactate, malate, methyl para-hyroxybenzoate, orthophenyl phenol, propionate, propyl para-hydroxybenzoate, sorbate, succinate or tartrate salts of sodium, potassium, rubidium, caesium, or any combination thereof. In an example, the additive may be potassium. Alternatively, the aggregation structure may be controlled or tuned in absence of an additive (e.g., in absence of an alkali metal salt such as potassium). Carbon black produced using the methods described herein may be a native carbon black. A native carbon black may be a carbon black produced in the absence of a chemical additive used to control structure. The method may include providing a mixed non-hydrogenous and hydrogen plasma gas. For example, the plasma gas may include greater than or equal to about 50 mol % non-hydrogenous gas. The carbon particles generated may have a DBP structure of greater than or equal to about 100 mL/100 g carbon particles. The carbon particles may be a native carbon particle. The native carbon particles generated using a mixed plasma gas with greater than or equal to about 50 mol % non-hydrogenous gas may have a DBP structure that is at least about 10%, 20%, 30%, 40%, 50%, 60%, 70%, 80%, 90%, or more greater than native carbon particles generated using a mixed plasma gas with greater than or equal to about 80 mol % hydrogen. In an example, the native carbon particles generated using a mixed plasma gas with greater than or equal to about 50 mol % non-hydrogenous gas may have a DBP structure that is at least about 30% greater than native carbon particles generated using a mixed plasma gas with greater than or equal to about 80 mol % hydrogen.

The plasma source may be a three-phase plasma torch. Power may be supplied to the plasma torch by a multi-stage transformation power supply controlled in current. The multi-stage power supply may be configured to provide or may provide up to about 250 kilovolt-amps (kVA) at 50 hertz (Hz). The power supply may provide from about 0 kilowatts (kW) to 50 kW at a frequency from about 0 hertz (Hz) to about 1 megahertz (MHz). A thermodynamic equilibrium arc discharge may be generated and alternate between electrode tips. The plasma torch may include at least 1, 2, 3, 4, 5, 6, or more electrodes. In an example, the plasma torch includes three electrodes and the plasma alternates between the three electrode tips. The electrode(s) may be formed of any conductive material capable of producing a plasma and capable of withstanding temperatures of 3000° C. or higher. The electrodes may be formed of the same material or the different electrodes may be formed of different materials. The electrode(s) may comprise graphite, carbon-carbon composite, reticulated vitreous carbon (RVC), glassy carbon, amorphous carbon, pyrolytic carbon, or any combination thereof. In an example, the electrodes may be formed of or comprise graphite.

Electrodes may be consumable and may be progressively consumed during the pyrolysis process due to erosion. Lowering hydrogen content in the reaction gas (e.g., also called plasma gas, dilution gas, or carrier gas) may reduce consumption of reactor components, such as graphite reactor components (e.g., electrodes(s), liners, etc.). Consumption of reactor components may occur in high temperature, high hydrogen environments as the hydrogen gas may react with the carbon at the surface (e.g., graphite surface) to generate gas phase hydrocarbons which may be removed from the process in the effluent gas. Consumption of the carbon at the surface of the reactor components may deteriorate the reactor structure, resulting in increased costs of certain components that may be consumed during a run. Removing hydrogen from the reaction gas may prevent or reduce the hydrogen attack on reactor surfaces, thereby increasing the life of components and reducing production costs. Electrode erosion may be reduced by using electrode(s) formed of materials with high thermal resistance (e.g., graphite). Alternatively, or in addition to, electrode erosion may be reduced by reducing reaction temperatures or reducing the concentration of hydrogen within the reactor. The electrode(s) may be consumed at a rate of no more than about 5 kilograms carbon per megawatt-hour (kg-carbon/MW-hr), 4 kg-carbon/MW-hr, 3 kg-carbon/MW-hr, 2 kg-carbon/MW-hr, 1.5 kg-carbon/MW-hr, 1 kg-carbon/MW-hr, 0.8 kg-carbon/MW-hr, 0.6 kg-carbon/MW-hr, 0.4 kg-carbon/MW-hr, 0.2 kg-carbon/MW-hr, 0.1 kg-carbon/MW-hr, or less. In an example, the electrode(s) are consumed at a rate of no more than about 0.6 kg-carbon/MW-hr.

Erosion or wear of the electrode(s) may modify the quality or stability of the produced plasma. To maintain a consistent plasma the electrode(s) may be fixed in place by an electrode holder. The electrode holder may be configured to control or may otherwise control the position of the electrodes(s) in the discharge zone. Electrode wear may change the dimensions of the electrode(s) and, as the dimensions of the electrode(s) change, the holder may adjust the electrode(s) position in real time (e.g., simultaneously with the pyrolysis reaction). The rate of electrode repositioning may be equal to or substantially equal to the erosion rate of the electrode(s).

Reactor fouling may also increase the costs and complexity of solid carbon and hydrogen manufacturing. Reducing hydrogen concentration in the reactor may reduce reactor fouling. Reactor fouling may be depositions of solid carbon onto parts of the reactor from the gas phase reaction. Fouling may alter the reactor geometry, block injection ports, alter the flow of gases in the reactor, or any combination thereof. Decreasing hydrogen content of the reaction gas (e.g., also called plasma gas, dilution gas, or carrier gas) may accelerate the conversion of hydrocarbons to products. By removing or reducing hydrocarbon gases that cause fouling, the quantity of fouling generated may be reduced. Reducing fouling may also reduce manufacturing costs by permitting the reactor to run longer without shutdowns for maintenance. On a mole basis, less than or equal to about 20%, 15%, 10%, 8%, 6%, 5%, 4%, 3%, 2%, 1%, or less of the input carbon may be converted to foul. In an example, less than or equal to about 10% of the input carbon is converted to foul. In another example, less than or equal to about 4% of the input carbon may be converted to fouling.

The system may further comprise a quench system. The quench system may use a hydrogen or non-hydrogen gas to cool the produced carbon particles, effluent gas, or both. The quenching system may be configured to cool or may otherwise cool a lower region of the reactor such that the carbon particles, effluent gas, or particles leave the reactor at a temperature sufficiently low to be compatible with the filter system(s). The quenching gas may be hydrogen, nitrogen, argon, krypton, neon, carbon monoxide, carbon dioxide, or any combination thereof. The quench may also include feedstock as there may be residual feedstock and high molecular weight carbonaceous components in the recycle stream. In an example, non-purified hydrogen (e.g., hydrocarbon contaminated hydrogen) may be used as the quench. The quench may be a mixed hydrogen gas and the mixed hydrogen gas may comprise from about 0.1 mol % to 4% hydrocarbon. In an example, the quenching gas comprises hydrogen, argon, nitrogen, or any combination thereof. In an example, the quenching gas comprises or is hydrogen. The quenching gas (e.g., hydrogen or hydrogen mixture) may be injected into the quenching system at a flow rate from about 50 Newton-meters cubed per hour (Nm³/hr) to 100 Nm³/hr, 50 Nm³/hr to 150 Nm³/hr, 50 Nm³/hr to 200 Nm³/hr, 50 Nm³/hr to 250 Nm³/hr, 50 Nm³/hr to 300 Nm³/hr, 50 Nm³/hr to 400 Nm³/hr, 50 Nm³/hr to 500 Nm³/hr, 100 Nm³/hr to 150 Nm³/hr, 100 Nm³/hr to 200 Nm³/hr, 100 Nm³/hr to 250 Nm³/hr, 100 Nm³/hr to 300 Nm³/hr, 100 Nm³/hr to 400 Nm³/hr, 100 Nm³/hr to 500 Nm³/hr, 150 Nm³/hr to 200 Nm³/hr, 150 Nm³/hr to 250 Nm³/hr, 150 Nm³/hr to 300 Nm³/hr, 150 Nm³/hr to 400 Nm³/hr, 150 Nm³/hr to 500 Nm³/hr, 200 Nm³/hr to 250 Nm³/hr, 200 Nm³/hr to 300 Nm³/hr, 200 Nm³/hr to 400 Nm³/hr, 200 Nm³/hr to 500 Nm³/hr, 250 Nm³/hr to 300 Nm³/hr, 250 Nm³/hr to 400 Nm³/hr, 250 Nm³/hr to 500 Nm³/hr, 300 Nm³/hr to 400 Nm³/hr, 300 Nm³/hr to 500 Nm³/hr, or 400 Nm³/hr to 500 Nm³/hr. In an example, the quenching gas may be provided to the quenching system at a flow rate from about 100 Nm³/hr to 200 Nm³/hr. In another example, the quenching gas may be nitrogen and the nitrogen may be provided to the quenching system at a flow rate from about 100 Nm³/hr to 200 Nm³/hr.

The reactor may be equipped with various diagnostic and analytical devices such as, but not limited to, temperature probes, pressure probes, optical pyrometry, electrical probes, high-speed cameras, optical emission spectrometry, or any combination thereof. The reactor may further comprise a window configured to permit or that permits optical access to the internal volume of the reactor. Non-limiting examples of window materials include quartz, borosilicate, fused silica, or sapphire.

Components of the effluent gas (e.g., non-hydrogenous gas, hydrogen, gaseous byproducts, etc.) may be separated using one or more of pressure swing adsorption (PSA), membrane separation, cryogenic separation, absorption columns, stripping columns, gas compressors, or any combination thereof.

The system may further comprise various separation assemblies. Solid carbonaceous materials may be separated from gaseous components. Separation units or hydrogen/tail gas removal units may include, but are not limited to, pressure swing adsorption devices, cryogenic separation devices, molecular sieves, or the like, or any combination thereof. The pressure swing adsorption (PSA) device may be configured to separate or purify components from a gas stream (e.g., components from a gas stream generated by a reactor as described elsewhere herein). The PSA device can comprise use of adsorption and the characteristics of the different components of a gas mixture (e.g., molecular size, dipole moment, etc.) to selectively pass through components of the mixture. For example, a PSA device can be used to separate hydrogen out of a reactor gas mixture. In this example, the PSA device can use the small size of hydrogen to separate the hydrogen by passing the gas mixture over a porous bed (e.g., a bed of porous zeolite) that can act as a sieve. In this example, the hydrogen can pass through the sieve while larger species in the gas mixture are filtered out by becoming trapped in the sieves. In this example, the sieves can saturate with the larger gases, at which point the bed can be removed and regenerated through removal of the larger gas species. A plurality of PSA devices can be used in parallel or in series. For example, a plurality of PSA devices can be set in parallel to permit continuous processing of gases while a subset of the PSA devices are being regenerated. A PSA device can be operated at a pressure of at least about 1, 5, 10, 11, 12, 13, 14, 15, 16, 17, 18, 19, 20, 21, 22, 23, 24, 25, 26, 27, 28, 29, 30, or more bar gauge (barg). A PSA device can be operated at a pressure of at most about 30, 29, 28, 27, 26, 25, 24, 23, 22, 21, 20, 19, 18, 17, 16, 15, 14, 13, 12, 11, 10, 5, or fewer bar gauge (barg). A PSA device can be operated at a pressure in a range as defined by any two of the proceeding values. For example, a PSA device can be operated at a pressure between about 13 and about 24 barg. A PSA device may be operated at a gas inlet temperature of at least about −50, −45, −40, −35, −30, −25, −20, −15, −10, −5, 0, 5, 10, 15, 20, 25, 30, 35, 40, 45, 50, 55, 60, 65, 70, or more degrees Celsius. A PSA device may be operated at a gas inlet temperature of at most about 70, 65, 60, 55, 50, 45, 40, 35, 30, 25, 20, 15, 10, 5, 0, −5, −10, −15, −20, −25, −30, −45, −50, or less degrees Celsius. For example, the PSA may operate at a temperature above where a component of the gas mixture condenses.

The system may further comprise a cryogenic separation device. A cryogenic separation device may be configured to separate components (e.g., different gases of a gas mixture) through utilization of cryogenic (e.g., sub-ambient) temperatures. For example, a cryogenic separation device can be configured to cool a mixture until all components of the mixture have condensed, and subsequently utilize increases in temperature or pressure to remove (e.g., boil off) components in order to separate them. Cryogenic separation may provide high purities of the components of the gas mixture (e.g., hydrogen).

The system may further comprise a filter assembly. The method may further comprise using the filter assembly to separate the carbon particles from the non-hydrogenous gas. The filter assembly may include or be integrated with a packaging device configured to sample the produced carbon particles. The sampling may be manual sampling or automatic sampling. In an example, sampling may be automatic.

Once separated from a gas mixture, hydrogen from the reactor can be further purified. In some cases, the hydrogen is of sufficient purity upon removal from the gas mixture (e.g., no further purification may be performed). In some cases, the hydrogen is purified by a PSA device, a cryogenic separation device, molecular sieves, or the like, or any combination thereof. In some cases, the hydrogen can be pressurized upon removal from the gas mixture. For example, the hydrogen can be pressurized prior to being fed into a purification apparatus. Subsequent to purification, the hydrogen can be of a purity of at least about 50, 60, 70, 80, 85, 90, 91, 92, 93, 94, 95, 96, 97, 98, 99, 99.9, 99.99, 99.999, 99.9999, 99.99999, or more percent (e.g., percent by mole, weight, or volume). Subsequent to purification, the hydrogen can be at a purity of at most about 99.99999, 99.9999, 99.999, 99.99, 99.9, 99, 98, 97, 96, 95, 94, 93, 92, 91, 90, 85, 80, 70, 60, 50, or less percent (e.g., percent by mole, weight, or volume). The gas removed from the hydrogen during purification may comprise hydrocarbons (e.g., methane, ethane, ethylene, acetylene, propene, benzene, toluene, naphthalene, anthracene, etc.), hydrogen, nitrogen, hydrogen cyanide, carbon monoxide, noble gases (e.g., argon, neon, krypton, etc.), or the like, or any combination thereof. The gas removed from the hydrogen may comprise at least about 1, 2, 3, 4, 5, 6, 7, 8, 9, 10, 11, 12, 13, 14, 15, 16, 17, 18, 19, 20, 21, 22, 23, 24, 25, or more percent by mole of the gas mixture. The gas removed from the hydrogen may comprise at most about 25, 24, 23, 22, 21, 20, 19, 18, 17, 16, 15, 14, 13, 12, 11, 10, 9, 8, 7, 6, 5, 4, 3, 2, 1, or less percent by mole of the gas mixture.

The system or process may further comprise a high pressure degassing apparatus. Carbon particles as described elsewhere herein (e.g., carbon black, etc.) generated by the processes described elsewhere herein can be directed into the top of the degassing apparatus as indicated. The carbon particles can initially contact a filter prior to the high pressure degassing apparatus, and fall from the filter into the top of the apparatus as shown. The carbon particles can contact the rotary valve. The rotary valve can be configured to meter the carbon particles by dropping the carbon particles through open airlock valves into the degassing vessel. The presence of the rotary valve may prevent too many carbon particles from entering the degassing vessel at once. The rotary valve may also provide an amount of backflow protection against gases from the degassing vessel flowing back. The carbon particles can collect in the degassing vessel until a predetermined amount of carbon particles has been reached. Subsequently, the rotary valve and the airlock valves can be closed, and the vent valve can be opened. The vent valve opening can relieve the gas at pressure in the degassing vessel (e.g., if the carbon particles are introduced to the vessel under pressure) and place the degassing vessel at atmospheric pressures. The vent valve can then be closed, and an inert purge valve can be opened to permit flow of inert gases (e.g., inert gases as described elsewhere herein). The inert gases may be configured to displace or dilute gases associated (e.g., adsorbed) with the carbon particles. For example, combustible or explosive gases (e.g., hydrogen, hydrocarbons, etc.) can be adsorbed to the surface of the carbon particles, and the inert gases can displace the combustible or explosive gases. Subsequent to the introduction of the inert gases, the purge valve can be closed, and the vent valve can be opened to vent the mixture of the inert gas and the gases associated with the carbon particles. The purging with inert gases can be repeated until the carbon particles are considered inert (e.g., the gases within the carbon particles are present at a safe level). The carbon particles can then be removed from the degassing vessel via airlock valves. For example, the airlock valves can be opened and the carbon particles can fall out of the degassing vessel via gravity. The airlock valves can then be closed and the process repeated for another batch of carbon particles.

Use of a high pressure degassing apparatus may enable collection of gases associated with the carbon particles (e.g., hydrogen) at elevated pressures. For example, the hydrogen adsorbed to the pores of the carbon particles can be collected at the same elevated pressure as the reactor system is operated at. Recovering the gases at elevated pressures can enable use of the gases in elevated pressure systems (e.g., high pressure chemical synthesis, combustion, fuel cells, etc.) without the use of a secondary pressurizing apparatus. Thus, the gases can be more easily used in downstream processes due to the elevated pressure of the gases. This can reduce engineering requirements and improve the functioning of systems as compared to if the gases were at lower pressures.

Carbon particle samples may be analyzed using transmission electron microscopy (TEM), scanning electron microscopy (SEM), ultrasonic dispersion according to ASTM D3849, or any combination thereof. TEM or SEM may be used to characterize particle morphology. Ultrasonic dispersion may be performed using chloroform to disperse carbon particles on the surface of a mesh copper grid (e.g., 200 mesh copper grid) supporting a hollowed carbon membrane. Carbon particles may be further analyzed using Brunauer-Emmett-Teller (BET) analysis to characterize primary particle size, DBP absorption to characterize aggregate structure, transmission of toluene extract (TOTE) analysis, X-ray diffraction (XRD), or any combination thereof.

Effluent gas may also be sampled and analyzed during carbon particle and hydrogen production. The effluent gas may be sampled after the filtering system and before gas separation. Gas sampling may be performed at discreet time points or continuously. Sample gas may be delivered to a gas analysis bench. The gas analysis bench may include thermal conductivity detection (TCD), non-diffractive infra-red analysis (NDIR), quantum cascade laser analysis (QCL), gas chromatography, Raman, Fourier transform infrared (FTIR), mass spectroscopy, or any combination thereof. Gas sample analysis may include measuring concentration profiles of various chemical species including, but not limited to, methane, acetylene, ethylene, ethane, carbon oxides, or any combination thereof. In an example, carbon oxides (e.g., carbon monoxide, carbon dioxide, etc.) may be measure during the transient heat-up phase of the reactor. In another example, carbon oxides may be measured during all phases of the pyrolysis reaction. Gas analysis may be performed during production or subsequent to production to monitor hydrocarbon feedstock conversion and chemistry of hydrocarbon feedstock conversion. Such analysis may further be used to determine in-situ process conversion rate.

Monitoring carbon particle and effluent gas characteristics during the production process may permit modulation of process parameters to obtain a targeted carbon particle. Process parameters that may be modulated may include, but are not limited to, plasma power, mixture temperature, flow rates, dilution ratio, or any combination thereof.

Using non-hydrogenous plasma gas may increase the energy efficiency of the carbon particle production process. In an example, using non-hydrogenous plasma gas (e.g., a plasma gas with greater than or equal to about 50% non-hydrogenous gas) may permit the production of higher surface area carbon black using approximately the same overall energy input as similar processes and systems using hydrogen plasma gases or predominantly hydrogen-based plasma gases (e.g., greater than or equal to about 80% hydrogen). In another example, using non-hydrogenous plasma gas may permit the production of higher surface area carbon black with less energy input on the front end (e.g., generating plasma) than similar systems and processes using hydrogen as the plasma gas. For example, using non-hydrogenous gas may permit a 15% reduction in energy use in the reactor (e.g., to generate the plasma).

The non-hydrogenous gas may not be consumed in the reaction. The non-hydrogenous gas may be recycled back to the reactor. A small amount of non-hydrogenous gas may be lost from the system due to leakage. The system may have low leakage in that greater than or equal to about 80%, 85%, 90%, 95%, 98%, or more of the non-hydrogenous gas may be returned to the reactor. In an example, greater than or equal to about 90 percent by volume (vol %) of the non-hydrogenous gas provided to the reactor is returned to the reactor in the separated gas. In another example, greater than or equal to about 98 vol % of the non-hydrogenous gas provided to the reactor is returned to the reactor in the separated gas.

Small scale three-phase alternating current (AC) plasma systems may have a high energy intensity because a significant amount of energy is lost through water cooling circuits (e.g., see Table 1 of Example 1 showing that energy intensity related to hydrogen production may be approximately 100 and 86 kilowatt-hours per kilogram hydrogen for Case A and B, respectively). The energy efficiency of high temperature thermal processes may increase as scale increases, see for example, Example 2.

The systems and methods described herein may be integrated with, coupled to, or otherwise usable with one or more computer systems. The one or more computer systems may be configured to implement or may be otherwise operable to implement the methods described elsewhere herein or monitor the status of the systems described elsewhere herein. For example, one or more computer systems may be used to monitor product or equipment temperature at various points in the process, control or monitor process conditions, such as non-hydrogenous gas, hydrocarbon feedstock, or separated gas flow rates, control or monitor inlet or effluent gas concentrations, control or monitor pretreatment or post-reactor conditions, or any combination thereof. The one or more computer systems may be configured to monitor or may monitor root mean square current and voltages for plasma phase (e.g., each of the three phases for a three phase system), gas flow rates at input and output, input and output water temperatures in systems comprising water cooling loops, water flow rates per loop for systems comprising water cooling loops, or any combination thereof. The one or more computer systems may further monitor internal reactor wall temperatures at different locations within the reactor using, for example, optical pyrometers and Type C thermocouples (e.g., tungsten/rhenium based thermocouples). The average reactor temperatures may be usable as or as an estimate for mean reaction temperature.

### Carbon Particle Compositions

The carbonaceous feedstock may comprise a chemical with a formula of CH or CₙHₓO_{y} where n is an integer, x is (i) between 1 and 2n+2 or (ii) less than 1 (e.g., for coal, coal tar, pyrolysis fuel oil, etc.), and y is between 0 and n. Examples of carbonaceous materials may include, but are not limited to, linear hydrocarbons (e.g., methane, ethane, propane, butane, etc.), cyclic hydrocarbons (e.g., cyclopropane, cyclobutene, cyclopentane, cyclohexane, etc.), aromatic hydrocarbons (e.g., benzene, toluene, xylenes, naphthalene, methyl naphthalene, pyrolysis fuel oil, coal tar, coal, heavy oil, oil, bio-oil, bio-diesel, other biologically derived hydrocarbons, etc.), unsaturated hydrocarbons (e.g., ethylene, propylene, acetylene, butadiene, styrene, etc.), oxygenated hydrocarbons (e.g., alcohols, ethanol, propanol, phenol, ketones, esters, ethers, carboxylic acids, anhydrides, etc.), or the like, or any combination thereof. The carbonaceous material may comprise a plurality of different carbonaceous materials. The carbonaceous feedstock or hydrocarbon may comprise at least about 1, 2, 3, 4, 5, 6, 7, 8, 9, 10, or more different carbonaceous materials. The carbonaceous material may comprise at most about 10, 9, 8, 7, 6, 5, 4, 3, 2, or 1 different carbonaceous materials. The carbonaceous material may comprise at least about 5, 10, 15, 20, 25, 30, 35, 40, 45, 50, 55, 60, 65, 70, 75, 80, 85, 90, 95, 96, 97, 98, 99, 99.9, or more percent by weight of a single carbonaceous material as described above. The carbonaceous material may comprise at most about 99.9, 98, 97, 96, 95, 90, 85, 80, 75, 70, 65, 60, 55, 50, 45, 40, 35, 30, 25, 20, 15, 10, 5, or less percent by weight of a single carbonaceous material as described above. For example, the carbonaceous material may comprise at least about 70 percent by weight methane, ethane, or propane. In another example, the carbonaceous material can comprise at least about 70 percent by weight of a mixture of methane, ethane, and propane. The carbonaceous material may comprise a percent by weight of a single carbonaceous material as defined by any two of the preceding values. For example, the carbonaceous material may comprise from about 50 to about 70 percent of a single carbonaceous material.

The systems and methods described herein may produce a carbon product with a greater carbon-14 to carbon-12 ratio than an identical system that uses a fossil fuel hydrocarbon feedstock. For example, a carbon product produced using a fossil fuel feedstock can have a carbon-14 to carbon-12 ratio of greater than about 3*10⁻¹³. The carbon product as described herein can have a carbon-14 to carbon-12 ratio of greater than about 3*10⁻¹³. Carbon products produced by the systems and methods described herein may have over 10% more carbon-14 than carbon products produced from a fossil fuel hydrocarbon feedstock. Carbon products produced by the systems and methods described herein may have over 5% more carbon-14 than carbon products produced from a fossil fuel hydrocarbon feedstock.

The carbonaceous material may comprise carbon particles. The carbon particles may comprise carbon black. Examples of carbon particles include, but are not limited to, carbon black, coke, needle coke, graphite, large ring polycyclic aromatic hydrocarbons, activated carbon, or the like, or any combination thereof. The carbon particles may be produced by the process at a yield greater than a yield of carbon particles formed by the reactor when operated at a lower pressure than the pressure of the process (e.g., about 1 bar, less than about 1.5 bar, etc.). The carbon particles may be produced at a yield of at least about 5, 10, 15, 20, 25, 30, 35, 40, 45, 50, 55, 60, 65, 70, 75, 80, 81, 82, 83, 84, 85, 86, 87, 88, 89, 90, 91, 92, 93, 94, 95, 96, 97, 98, 99, 99.9, or more percent. The carbon particles may be produced at a yield of at most about 99.9, 99, 98, 97, 96, 95, 94, 93, 92, 91, 90, 89, 88, 87, 86, 85, 84, 83, 82, 81, 80, 75, 70, 65, 60, 55, 50, 45, 40, 35, 30, 25, 20, 15, 10, 5, or less percent. The yield of the carbon particles may be a value in a range as defined by any two of the proceeding values. For example, the yield of the carbon particles may be from about 90 to about 99 percent. The yield of the carbon particles in the process may be greater than a yield of carbon particles formed in a different reactor of a same size as the reactor of the process when the different reactor is operated at a pressure less than that of the reactor of process.

Carbonaceous material (e.g., carbon particles) may be generated at a yield (e.g., yield based upon feedstock conversion rate, based on total hydrocarbon provided, on a weight percent carbon basis, or as measured by moles of product carbon vs. moles of reactant carbon) of, for example, greater than or equal to about 1%, 5%, 10%, 25%, 50%, 55%, 60%, 65%, 70%, 75%, 80%, 85%, 90%, 91%, 92%, 93%, 94%, 95%, 96%, 97%, 98%, 99%, 99.5% or 99.9%. Alternatively, or in addition, the carbonaceous material (e.g., carbon particles) may be generated at a yield (e.g., yield based upon feedstock conversion rate, based on total hydrocarbon provided, on a weight percent carbon basis, or as measured by moles of product carbon vs. moles of reactant carbon) of, for example, less than or equal to about 100%, 99.9%, 99.5%, 99%, 98%, 97%, 96%, 95%, 94%, 93%, 92%, 91%, 90%, 85%, 80%, 75%, 70%, 65%, 60%, 55%, 50%, 25% or 5%.

The carbon particles may comprise larger carbon particles. The larger carbon particles may have an equivalent sphere greater than about 0.5, 0.6, 0.7, 0.75, 0.8, 0.9, 1, 1.1, 1.2, 1.25, 1.3, 1.4, 1.5, 1.6, 1.7, 1.75, 1.8, 1.9, 2, 2.1, 2.2, 2.25, 2.3, 2.4, 2.5, 2.6, 2.7, 2.75, 2.8, 2.9, 3, 4, 5, or more micrometers and, for example, a nitrogen surface area (N₂SA) of less than about 50, 40, 30, 20, 15, 10, 5, or less square meters per gram (m²/g). For example, the larger carbon particles may have an equivalent sphere diameter of at least about 2 micrometers and an N₂SA of less than about 15 square meters per gram. The larger carbon particles may be caught in a catchpot as described elsewhere herein. The carbon particles may comprise carbon particles with an equivalent sphere of less than about 5, 4, 3, 2.9, 2.8, 2.75, 2.7, 2.6, 2.5, 2.4, 2.3, 2.25, 2.2, 2.1, 2, 1.9, 1.8, 1.75, 1.7, 1.6, 1.5, 1.4, 1.3, 1.25, 1.2, 1.1, 1, 0.9, 0.8, 0.75, 0.7, 0.6 0.5, 0.4, 0.3, 0.25, 0.2, 0.1, or fewer micrometers. For example, the carbon particles can have an equivalent sphere diameter of less than about 2 micrometers. The carbon particles may have a ratio of larger carbon particles (e.g., with an equivalent sphere diameter of greater than about 2 micrometers) to carbon particles with an equivalent sphere of less than about 2 micrometers of about 0/100, 5/95, 10/90, 15/85, 20/80, 25/75, 30/70, 35/65, 40/60, 45/55, 50/50, 55/45, 60/40, 65/35, 70/30, 75/25, 80/20, 85/15, 90/10, or 100/0. The methods and systems described herein may be configured to be tuned to generate a predetermined ratio of larger carbon particles to carbon particles with a volume equivalent sphere of less than about 2 micrometers. The equivalent sphere diameter may be measured by centrifugal particle sedimometry.

A surface area of the carbon particles may be modified by altering an gas composition in the reactor (e.g., via hydrogen concentration). The surface area of the carbon particles may be increased by reducing a hydrogen concentration or generating the particles in the presence of one or more additives. Examples of additives include, but are not limited to, hydrocarbons (e.g., hydrocarbons a described elsewhere herein, hydrocarbon gases), silicon-containing compounds (e.g., siloxanes, silanes, etc.), aromatic additives (e.g., benzene, xylenes, polycyclic aromatic hydrocarbons, etc.), or the like, or any combination thereof. The reactor may be an oxygen-free environment. In an example, the carbon particles are generated in absence of one or more additives (e.g., no additives may be added to the reactor). The surface area (e.g., N2SA and/or statistical thickness surface area (STSA)) greater than or equal to about 5 m²/g, 10 m²/g, 15 m²/g, 20 m²/g, 25 m²/g, 30 m²/g, 35 m²/g, 40 m²/g, 45 m²/g, 50 m²/g, 60 m²/g, 70 m²/g, 80 m²/g, 81 m²/g, 90 m²/g, 100 m²/g, 120 m²/g, 140 m²/g, 160 m²/g, 180 m²/g, 200 m²/g, 250 m²/g, 300 m²/g, 350 m²/g, 400 m²/g, or greater. Alternatively, or in addition, the surface area (e.g., N2SA and/or STSA) may be, for example, less than or equal to about 400 m²/g, 350 m²/g, 300 m²/g, 250 m²/g, 200 m²/g, 180 m²/g, 160 m²/g, 140 m²/g, 120 m²/g, 100 m²/g, 90 m²/g, 80 m²/g, 70 m²/g, 60 m²/g, 50 m²/g, 45 m²/g, 40 m²/g, 35 m²/g, 30 m²/g, 25 m²/g, 20 m²/g, 15 m²/g, 10 m²/g, 5 m²/g or less. The STSA and N2SA may differ. The difference may be expressed in terms of an STSA/N2SA ratio. The STSA/N2SA ratio may be, for example, greater than or equal to about 0.4, 0.5, 0.6, 0.7, 0.75, 0.76, 0.77, 0.78, 0.79, 0.8, 0.81, 0.82, 0.83, 0.84, 0.85, 0.86, 0.87, 0.88, 0.89, 0.9, 0.91, 0.92, 0.93, 0.94, 0.95, 0.96, 0.97, 0.98, 0.99, 1, 1.01, 1.02, 1.03, 1.03, 1.05, 1.06, 1.07, 1.08, 1.09, 1.1, 1.11, 1.12, 1.13, 1.14, 1.15, 1.16, 1.17, 1.19, 1.20, 1.21, 1.22, 1.23, 1.24, 1.25, 1.26, 1.27, 1.28, 1.29, 1.3, 1.31, 1.32, 1.33, 1.34, 1.35, 1.37, 1.38, 1.39, 1.4, 1.45, 1.5, 1.6, 1.7, 1.8, 1.9 or 2. Alternatively, or in addition, the STSA/N2SA ratio may be, for example, less than or equal to about 2, 1.9, 1.8, 17, 1.6, 1.5, 145, 1.4, 1.39, 1.38, 1.37, 1.36, 1.35, 1.34, 1.33, 1.32, 1.31, 1.3, 1.29, 1.28, 1.27, 1.26, 1.25, 1.24, 1.23, 1.22, 1.21, 1.2, 1.19, 1.18, 1.17, 1.16, 1.15, 1.14, 1.13, 1.12, 1.11, 1.1, 1.09, 1.08, 1.07, 1.06, 1.05, 1.04, 1.03, 1.02, 1.01, 1, 0.99, 0.98, 0.97, 0.96, 0.95, 0.94, 0.93, 0.92, 0.91, 0.9, 0.89, 0.88, 0.87, 0.86, 0.85, 0.84, 0.83, 0.82, 0.81, 0.8, 0.79, 0.78, 0.77, 0.76, 0.75, 0.7, 0.6 or 0.5. In some examples, the surface area (e.g., N2SA or specific surface area) may be from about 40 m²/g to about 200 m²/g. The carbon particle(s) may have such surface areas in combination with one or more other properties described herein. The carbon particles or the additional carbon particles may have a nitrogen surface area (N2SA) of at least about 80 m²/g. The carbon particles, additional carbon particles, or both may have a surface specific surface area of at least about 50 square meters per gram (m²/g). The carbon particles or the additional carbon particles may have a surface area from about 50 m²/g to 200 m²/g.

The carbon particles (e.g., carbon black particles) may have a given structure. The structure may be expressed in terms of dibutyl phthalate (DBP) absorption, which measures the relative structure of carbon particles (e.g., carbon black) by determining the amount of DBP a given mass of carbon particles (e.g., carbon black) can absorb before reaching a specified visco-rheologic target torque. The structure of the carbon particles may be modified by generating particles in the presence of additives, as described elsewhere herein, that disrupt particle aggregation and decreasing structure. Alternatively, or in addition to, the structure of the carbon particles may be modulated by altering the concentration of hydrogen within the reactor. The carbon particles may have a DBP absorption of at least about 20 milliliters DBP per 100 grams carbon black (mL/100 g), 30 mL/100 g, 40 mL/100 g, 50 mL/100 g, 60 mL/100 g, 80 mL/100 g, 100 mL/100 g, 125 mL/100 g, 150 mL/100 g, 200 mL/100 g, 250 mL/100 g, 300 mL/100 g, 400 mL/100 g, 500 mL/100 g, or more. The carbon particles may have a DBP absorption of less than or equal to about 500 mL/100 g, 400 mL/100 g, 300 mL/100 g, 250 mL/100 g, 200 mL/100 g, 150 mL/100 g, 125 mL/100 g, 100 mL/100 g, 80 mL/100 g, 60 mL/100 g, 50 mL/100 g, 40 mL/100 g, 30 mL/100 g, 20 mL/100 g, or less. In an example, the carbon particles may be generated in absence of an additive (e.g., potassium) and may have a structure of greater than or equal to about 100 mL/100 g. In another example, the carbon particles may be generated in absence of an additive (e.g., potassium) and may have a structure of greater than or equal to about 150 mL/100 g.

Systems and methods of the present disclosure may be combined with or modified by other systems or methods (with appropriate modification(s)), such as chemical processing and heating methods, chemical processing systems, reactors and plasma torches described in U.S. Pat. Pub. No. US 2015/0210856 and Int. Pat. Pub. No. WO 2015/116807 (“SYSTEM FOR HIGH TEMPERATURE CHEMICAL PROCESSING”), U.S. Pat. Pub. No. US 2015/0211378 (“INTEGRATION OF PLASMA AND HYDROGEN PROCESS WITH COMBINED CYCLE POWER PLANT, SIMPLE CYCLE POWER PLANT AND STEAM REFORMERS”), Int. Pat. Pub. No. WO 2015/116797 (“INTEGRATION OF PLASMA AND HYDROGEN PROCESS WITH COMBINED CYCLE POWER PLANT AND STEAM REFORMERS”), U.S. Pat. Pub. No. US 2015/0210857 and Int. Pat. Pub. No. WO 2015/116798 (“USE OF FEEDSTOCK IN CARBON BLACK PLASMA PROCESS”), U.S. Pat. Pub. No. US 2015/0210858 and Int. Pat. Pub. No. WO 2015/116800 (“PLASMA GAS THROAT ASSEMBLY AND METHOD”), U.S. Pat. Pub. No. US 2015/0218383 and Int. Pat. Pub. No. WO 2015/116811 (“PLASMA REACTOR”), U.S. Pat. Pub. No. US2015/0223314 and Int. Pat. Pub. No. WO 2015/116943 (“PLASMA TORCH DESIGN”), Int. Pat. Pub. No. WO 2016/126598 (“CARBON BLACK COMBUSTABLE GAS SEPARATION”), Int. Pat. Pub. No. WO 2016/126599 (“CARBON BLACK GENERATING SYSTEM”), Int. Pat. Pub. No. WO 2016/126600 (“REGENERATIVE COOLING METHOD AND APPARATUS”), U.S. Pat. Pub. No. US 2017/0034898 and Int. Pat. Pub. No. WO 2017/019683 (“DC PLASMA TORCH ELECTRICAL POWER DESIGN METHOD AND APPARATUS”), U.S. Pat. Pub. No. US 2017/0037253 and Int. Pat. Pub. No. WO 2017/027385 (“METHOD OF MAKING CARBON BLACK”), U.S. Pat. Pub. No. US 2017/0058128 and Int. Pat. Pub. No. WO 2017/034980 (“HIGH TEMPERATURE HEAT INTEGRATION METHOD OF MAKING CARBON BLACK”), U.S. Pat. Pub. No. US 2017/0066923 and Int. Pat. Pub. No. WO 2017/044594 (“CIRCULAR FEW LAYER GRAPHENE”), U.S. Pat. Pub. No. US20170073522 and Int. Pat. Pub. No. WO 2017/048621 (“CARBON BLACK FROM NATURAL GAS”), Int. Pat. Pub. No. WO 2017/190045 (“SECONDARY HEAT ADDITION TO PARTICLE PRODUCTION PROCESS AND APPARATUS”), Int. Pat. Pub. No. WO 2017/190015 (“TORCH STINGER METHOD AND APPARATUS”), Int. Pat. Pub. No. WO 2018/165483 (“SYSTEMS AND METHODS OF MAKING CARBON PARTICLES WITH THERMAL TRANSFER GAS”), Int. Pat. Pub. No. WO 2018/195460 (“PARTICLE SYSTEMS AND METHODS”), Int. Pat. Pub. No. WO 2019/046322 (“PARTICLE SYSTEMS AND METHODS”), Int. Pat. Pub. No. WO 2019/046320 (“SYSTEMS AND METHODS FOR PARTICLE GENERATION”), Int. Pat. Pub. No. WO 2019/046324 (“PARTICLE SYSTEMS AND METHODS”), Int. Pat. Pub. No. WO 2019/084200 (“PARTICLE SYSTEMS AND METHODS”), and Int. Pat. Pub. No. WO 2019/195461 (“SYSTEMS AND METHODS FOR PROCESSING”), each of which is entirely incorporated herein by reference.

### Examples

### Example 1: Nitrogen and Mixed Nitrogen Diluent Gas

Methane conversion, carbon particle yield, and hydrogen yield may vary as a function of the composition of the diluent gas. Case A and Case B may show experimental results for two different compositions of diluent gases. The diluent gas may be the gas usable for or used for generating a plasma. In an example, the volumetric flow dilution ratio (DR), as described elsewhere herein, may be maintained at seven for both Case A and Case B. Table 1 shows an example summary of process conditions and yield results for Case A and Case B. As shown in Table 1, the process parameters for Case A and Case B may be substantially the same. Process conditions may be substantially the same for Case A and Case B, with the exception of the hydrogen to nitrogen ratio. For example, in Case A the ratio of hydrogen to nitrogen in the plasma gas may be approximately 0 to 100 and in Case B the ratio of hydrogen to nitrogen may be approximately 30 to 70. In both cases the plasma gal flow may be fixed at approximately 28 Nm³/hr and a dilution ratio of seven.

TABLE 1
Process parameters and yield for Case A and Case B

| Process Parameter | Case A | Case B |
|---|---|---|
| Mean Reactor Temperature, ° C. | 1670 | 1710 |
| H2—N2 in plasma gas | 0-100 | 30-70 |
| Mean Torch Power, kW | 69 | 60 |
| Total heat loss, kW | 34 | 35 |
| CH4 conversion, % | 98.7 | 99.4 |
| H₂ yield, % | 96.6 | 98.2 |
| Total solid carbon yield, % | 95 | 92 |
| Estimated Gas-phase carbon, % | 5 | 5 |
| Energy Intensity | 100 | 86 |
| kWh/kg H2 | | |
| Energy Intensity | 34 | 30 |
| kWh/kg Carbon | | |

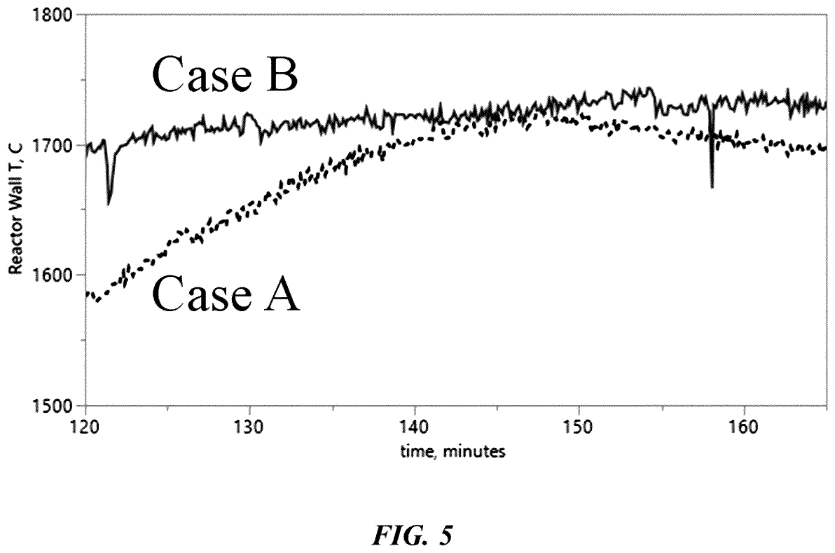

As shown in FIG. 5, the mean reactor temperature may vary by approximately 100° C. over the course of methane injection. Reaction time for Case A and Case B may be approximately 40 minutes, which may allow sufficient time for generation of sufficient quantities of solid product for subsequent analysis. The reactor temperature may increase upon the start of methane injection due to inception of particle-laden flow which may enhance heat transfer via radiation and may aid in transfer thermal energy from the plasma to the product gas. As shown in FIG. 5, Case A may reach a quasi-thermal steady state within about 20 minutes. Case B more time may be permitted for reactor heat up, thus permitting a thermal steady state condition during methane injection.

As shown in Table 1, methane conversion for both cases may be above 99%: 99.5% for Case A and 99.9% for Case B. The high conversion rate may be economically favorable at commercial scale. High methane conversion may result in high hydrogen yield for both conditions, for example, 96% for Case A and 98% for Case B. The remaining hydrogen may be contained in other gas phase hydrocarbons such as acetylene, ethylene, and other species that may or may not be measured by gas analysis instrumentation.

Total elemental carbon balances may be performed per run and include carbon mass produced and estimated from the gas analysis instrumentation. This method may not consider hydrocarbons larger than ethane and compounds formed and removed from the reactor may not take part in the carbon balance. The remaining carbon that may not be converted to solid form may be estimated bason on gas analysis data may be 5% in both Case A and Case B.

The carbon balance for Case A may be 100% and 97% for Case B. The 100% carbon balance in Case A may suggest that larger intermediate species, such as aromatics, may not be present in high quantities after the process gas exits the reactor. Alternatively, the inability to reach a 100% carbon balance in Case B may suggest incomplete feedstock conversion and persistence of intermediate gas phase species which may not be tracked by the gas analysis instrumentation.

Table 2 shows a comparison of analytically obtained solid carbon characteristics along with literature examples. While such comparison may not directly indicate performance of bulk plasma blacks in industrial applications such as rubber compounding, such comparisons may provide a means of comparison with other ASTM standardized carbon blacks. Reactor conditions may be further turned to obtain specific grades of carbon black. In both cases, bulk solid carbon may be produced at yields above 90%. X-ray diffraction (XRD) may be performed on bulk carbon samples from Case A, as shown in Table 2. As a comparison, the lattice constant (Lc) of carbon black produced by furnace processes may be between 1-3. The surface area of the carbon produced in both cases may be in the range of 90 to 110 m²/g, which may align well with the surface area of furnace blacks used for reinforcing grade applications (e.g., 80-100 m²/g). The concentration of toluene extractables may be similar to those from furnace processes.

TABLE 2
Comparison of select solid carbon analytical data with select
furnace black (N660, N330) and acetylene black data

| | | | | | Acetylene |
|---|---|---|---|---|---|
| | Case A | Case B | N660 | N330 | Black |
| XRD, Lc | 3. | N/A | 1.5 | 1.5 | 25 |
| d002, | 0.3501 | N/A | 0.335 | 0.335 | |
| N2SA, m²/g | 90-110 | 90-110 | 34 | 84 | 65 |
| Mean primary | | | 109 | 46 | 40 |
| particle | | | | | |
| diameter, nm | | | | | |
| DBP, mL/100 g | 240 | 194 | 90 | 102 | 250 |
| TOTE | 99.6 | 100 | >99.8 | >99.8 | |

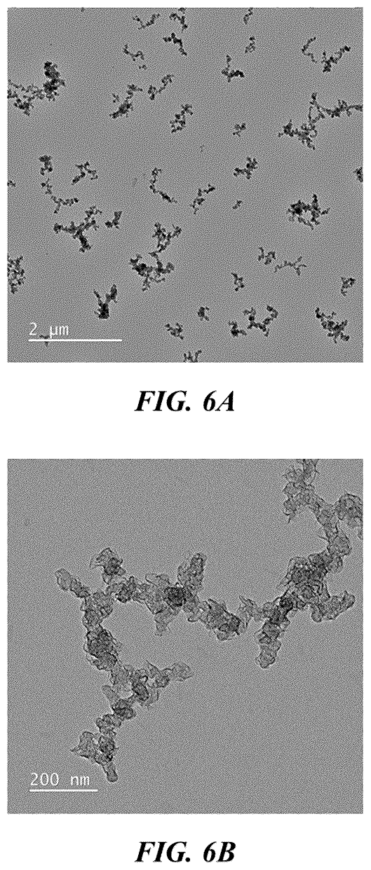

FIGS. 6A and 6B show TEM images obtained for Case A samples to investigate particle morphology. The particles may have aggregate morphologies similar to carbon black, although the primary particles do not appear to be as spherical and turbostratic as furnace-type black. This difference in appearance may be attributed to the higher reactor temperatures used for feedstock conversion and product yields relative to the furnace processes.

### Example 2: Energy Intensity of Methane Pyrolysis

As shown in Table 2 above, the energy intensity of a small scale three-phase alternating current (AC) plasma system may be high because of energy lost in the water cooling circuits. For example, the energy intensity of hydrogen production in Case A may be approximately 100 kilowatt-hours per kilogram hydrogen (kWh/kg H₂) and the energy intensity of hydrogen production in Case B may be approximately 86 kWh/kg H₂.

The energy efficiency of high temperature thermal processes may increase as scale increases. Table 3 shows a potential example of real-time operation data of an industrial scale facility with twelve units and an annual capacity of 50 kilotons of hydrogen and 180 kilotons of carbon black. The energy intensity obtained at this scale may be around 25 kWh/kg H₂. This energy intensity may be about 42% of the energy intensity of hydrogen generation using water electrolysis, which is around 60 kWh/kg H₂.

TABLE 3
Example yearly energy usage for industrial scale carbon black and
hydrogen production with and without hydrogen as a process gas

| | Electrical Consumption with | Electrical Consumption | |
|---|---|---|---|
| Process Stage | Hydrogen | with Non-Hydrogenous Gas | |
| Plasma Reactor | Electricity: 1077 Gigawatt-hour | 915 | GWh/y |
| (Front-End) | per year (GWh/y) | | |
| Carbon Black Back-End | Electricity: 34 GWh/y | 34 | GWh/y |
| Hydrogen Purification | Electricity: 96 GWh/y | 288 | GWh/y |
| Balance of Plant (BOP) | Electricity: 43.2 GWh/y | 44 | GWh/y |
| | TOTAL ELEC: 1250.2 GWh/y | 1282 | GWh/y |

### Example 3. Manufacture of Increased Surface Area Carbon Nanostructures

Carbon particles may be manufactured in a plasma pyrolysis reactor. The plasma source can operate at least about 500 kilowatts (kW) and a reaction temperature of 1750° C. with a carbon production rate of at least about 100 kilogram per hour (kg/h). Carbon samples may be generated in a test with low molecular weight reaction gas and high concentration of hydrogen. The resulting surface area of the carbon particles may be at least about 5 meter squared per gram (m²/g) and may fall in the range of semi-reinforcing grades of standard carbon black with respect to tire manufacturing. An equivalent test can be performed by modulating the composition of the hydrogen in the plasma or diluent gas while maintaining the other process parameters as constant. By increasing the molecular weight of the plasma gas and reducing the hydrogen gas concentration the surface area of the produced carbon particles may increase to fall within the range of reinforcing grades of carbon black that may be used in tire manufacturing.

### Example 4. Manufacture of Carbon Particles in Reduced Hydrogen Environments

A laboratory scale methane pyrolysis reactor may be used to generate carbon particles and hydrogen. The reactor may comprise a plasma torch that heats a gas before injecting methane feedstock into the heated gas. The gas may spend time in a hot reaction chamber before being quenched to stop the reaction. In the reaction chamber, the methane feedstock may be converted to hydrogen and carbon black. The data provided below may be produced by collecting the carbon produced by the reactor and analyzing it according to ASTM methods. Table 4 shows example conditions that may be used to produce carbon black.

TABLE 4
example operating conditions for hydrogen concentration testing

| Condition | Laboratory Scale | |
|---|---|---|
| Pressure | 1 | atm |
| Reaction Temperature | 1500 C.-2100 C. | |
| System Residence Time | 400 | ms |

| | |
|---|---|
| Feedstock | Methane |
| Non-hydrogen gas | Nitrogen, Argon, or Carbon |
| | Monoxide |

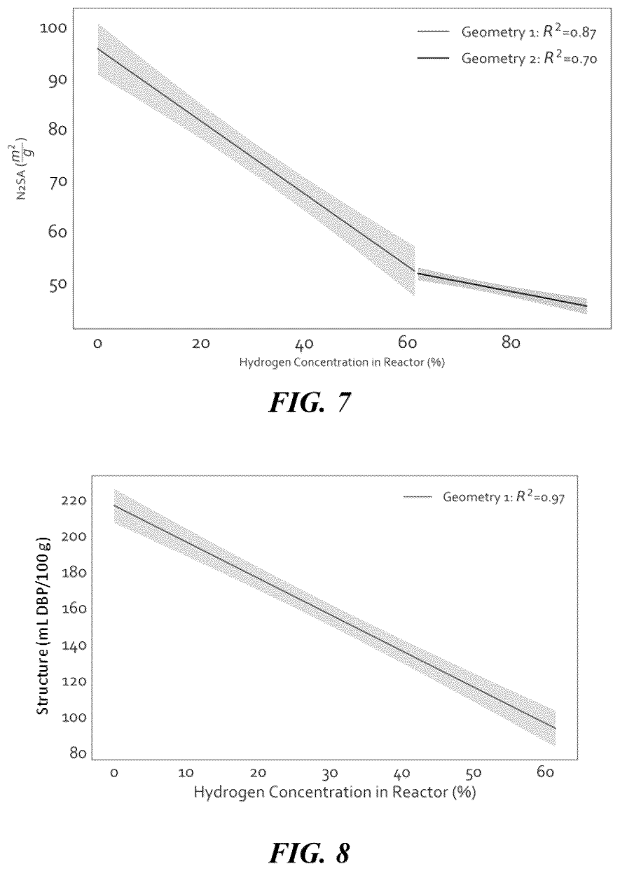

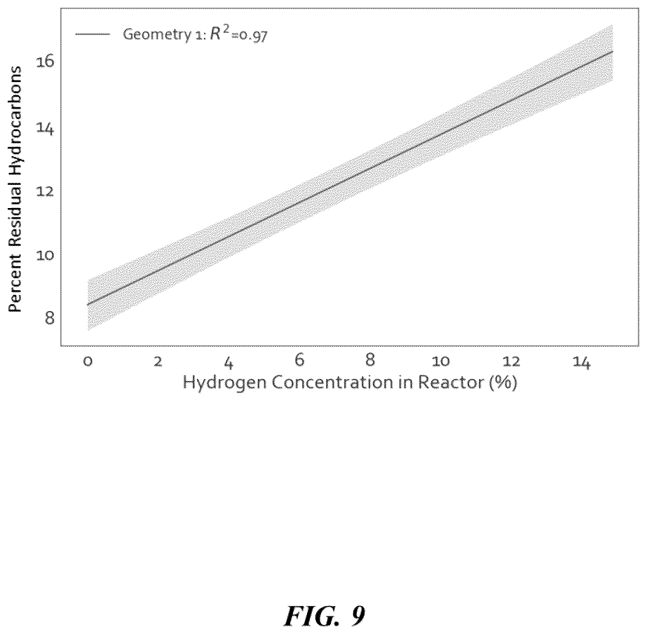

The amount of hydrogen in the reactor may be represented as a concentration of total amount of non-feedstock gas entering the system. This may be expressed as a molar percentage of the total flow and may be abbreviated as % H₂. FIG. 7 shows an example of carbon particle surface area as a function of hydrogen concentration. The surface area of the carbon particles may be measured by the nitrogen surface area (N2SA). FIG. 7 shows linear regression of a data set. As the amount of hydrogen in the gas phase of the reactor increases the surface area of the carbon particles may decrease. Alternatively, as the amount of hydrogen decreases the surface area of the particle may increase. The data shown in FIG. 7 may be obtained from reactors with two different geometries and the change in the geometry may not influence the surface area of the carbon particles. FIG. 8 shows an example of structure (DBP) as a function of hydrogen concentration. As with the normalized surface area, the structure may increase as the hydrogen concentration decreases. Data shown in FIG. 8 is from a single reactor geometry. FIG. 9 shows an example of the impact of hydrogen concentration on the quantity of unreacted hydrocarbons at a given reactor temperature. As the amount of hydrogen gas in the reactor increases so does the amount of residual hydrocarbons. For example, the amount of unreacted hydrocarbons may more than double from a 15% increase in the hydrogen concentration in the reactor.

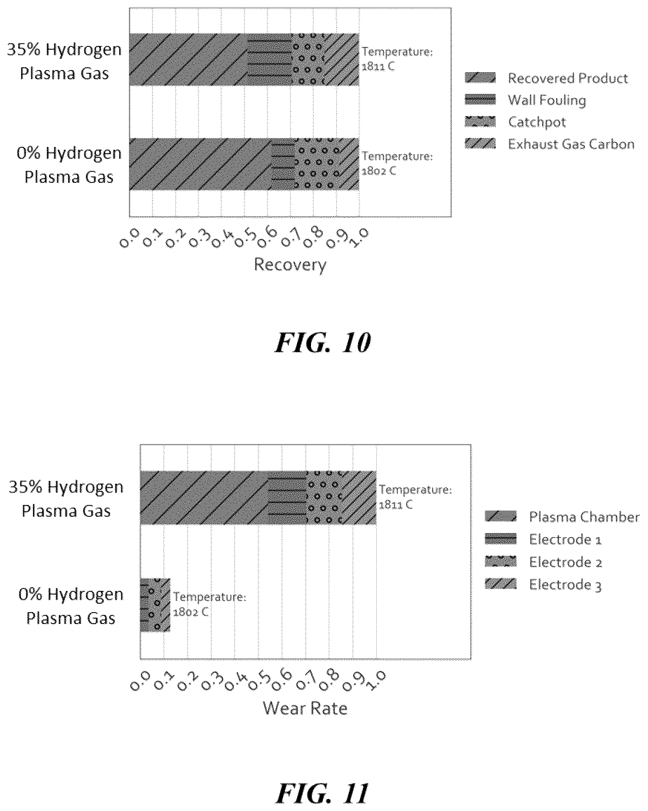

FIG. 10 shows an example of data showing the impact of hydrogen content on carbon particle recovery and fouling at substantially the same reaction temperatures. As shown in FIG. 10, carbon may exit the reactor via recovered product, wall fouling, Catchpot carbon mass, and exhaust gas carbon in the form of unreacted hydrocarbons. The catchpot may be a stainless steel vessel attached to the reactor exit which may allow for retaining of fouling material that falls off various internal reactor components during operation. The catchpot may be equipped with a port through which quench gas may be injected. The fouling may be too large to be entrained in the in the effluent gas and may fall into the catchpot due to gravity while the carbon particles may be entrained in the effluent stream. Catchpot carbon mass may include solid fouling from the wall that has fallen off the walls into the Catchpot. The amount of recovered product may be greater at 0% hydrogen concentrations than at 35% hydrogen concentrations. Additionally, the amount of wall fouling may be decreased at lower hydrogen concentration as compared to higher hydrogen concentration. The increase in Catchpot carbon mass may indicate that wall fouling may be less rigidly attached to the wall. Fouling that is less rigidly attached to the wall may be easier to remove and manage during maintenance intervals. FIG. 11 shows an example of equipment wear as a function of hydrogen concentration in the reactor. Reactors with 0% hydrogen concentrations show substantially less component wear than reactors with 35% hydrogen concentrations at substantially the same temperatures. For example, wear of the plasma chamber may be substantially eliminated, while electrode erosion may be significantly reduced. Overall, the reduction in wear may be approximately 90%, which may represent a significant reduction in consumable costs.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A method for making carbon particles, comprising:
(a) in a reactor, contacting a non-hydrogenous gas with a hydrocarbon feedstock in presence of a plasma, thereby obtaining (i) carbon particles and (ii) an effluent gas comprising hydrogen and the non-hydrogenous gas;
(b) separating at least a portion of the hydrogen from the non-hydrogenous gas of the effluent gas, thereby obtaining a separated gas comprising the non-hydrogenous gas;
(c) providing the separated gas, or a derivative thereof, comprising the non-hydrogenous gas to the reactor; and
(d) contacting the separated gas, or the derivative thereof, comprising the non-hydrogenous gas with additional hydrocarbon feedstock in presence of the plasma, thereby obtaining (iii) additional carbon particles and (iv) an additional effluent gas comprising hydrogen and the non-hydrogenous gas.

2. The method of claim 1, wherein the non-hydrogenous gas comprises one or more gases selected from the group consisting of nitrogen, helium, neon, krypton, argon, carbon monoxide, and carbon dioxide.

3. The method of claim 1, wherein the separated gas, or the derivative thereof, comprises less than or equal to about 50 mole % (mol %) hydrogen.

4. The method of claim 3, wherein the separated gas, or the derivative thereof, comprises less than or equal to about 25 mol % hydrogen.

5. (canceled)

6. The method of claim 1, further comprising, in (a), providing a gas mixture comprising the non-hydrogenous gas and hydrogen to the reactor.

7. The method of claim 6, wherein the gas mixture comprises an average molecular weight in a range from about 1 kg/kmol to about 90 kg/kmol.

8. The method of claim 6, wherein, in (a), a ratio of the non-hydrogenous gas to the hydrogen in the gas mixture is at least 2 to 1.

9. The method of claim 8, wherein in (a), the ratio of the non-hydrogenous gas to the hydrogen in the gas mixture is at least 10 to 1.

10. The method of claim 1, further comprising, in (c), providing a gas mixture comprising the separated gas, or a derivative thereof, and hydrogen to the reactor.

11. The method of claim 10, wherein, in (d), a ratio of the non-hydrogenous gas to the hydrogen is at least 2 to 1.

12. The method of claim 11, wherein, in (d), the ratio of the non-hydrogenous gas to the hydrogen is at least 10 to 1.

13. The method of claim 1, wherein, during or after (c), no hydrogen is provided to the reactor.

14. The method of claim 1, wherein the carbon particles or the additional carbon particles are carbon black.

15. The method of claim 1, further comprising, in (a), contacting the non-hydrogenous gas with the hydrocarbon feedstock at a temperature of no more than about 1900° C.

16. (canceled)

17. The method of claim 1, further comprising, in (d), contacting the separated gas, or the derivative thereof, with the additional hydrocarbon feedstock at a temperature of no more than about 1900° C.

18. (canceled)

19. The method of claim 1, wherein the carbon particles or the additional carbon particles have a specific surface area of at least about 40 square meters per gram (m²/g).

20. The method of claim 1, wherein the carbon particles or the additional carbon particles have a specific surface area in a range from about 40 square meters per gram (m²/g) to about 200 m²/g.

21. The method of claim 1, wherein the carbon particles or the additional carbon particles have a nitrogen surface area (N2SA) of at least about 40 m²/g.

22. The method of claim 1, wherein the carbon particles or the additional carbon particles have a dibutyl phthalate (DBP) absorption of at least about 100 milliliters per 100 grams of carbon particles (mL/100 g).

23. The method of claim 22, wherein the carbon particles are generated in presence of an additive that disrupts aggregation of the carbon particles.

24. The method of claim 23, wherein the additive comprises an alkali metal salt.

25. The method of claim 24, wherein the alkali metal salt comprises potassium.

26. The method of claim 22, wherein the carbon particles are generated in absence of an additive that disrupts particle aggregation.

27. (canceled)

28. (canceled)

29. The method of claim 1, wherein, in (a), at least about 80% of the hydrocarbon feedstock is converted to the carbon particles.

30. The method of claim 29, wherein, in (a), at least about 90% of the hydrocarbon feedstock is converted to the carbon particles.

31. (canceled)

32. The method of claim 1, wherein, in (d), conversion of the additional hydrocarbon feedstock to the additional carbon particles is at least about 80%.

33. The method of claim 32, wherein, in (d), conversion of the additional hydrocarbon feedstock to the additional carbon particles is at least about 90%.

34. (canceled)

35. The method of claim 1, further comprising producing the plasma with the aid of an electrode.

36. The method of claim 35, wherein, through (a)-(d), the electrode is consumed at a rate of no more than about 0.6 kg-carbon/MW-hr.

37. The method of claim 1, wherein the reactor comprises one or more graphite components, and wherein the one or more graphite components have a wear rate of less than or equal to about 0.6 kg-carbon/MW-hr.

38. The method of claim 1, further comprising, in (a) or (d), generating an amount of reactor fouling that is no more than about 4 kilogram carbon fouling per 100 kilograms of carbon injected (kg/100 kg).

39. The method of claim 1, wherein the hydrocarbon feedstock comprises methane.

40. (canceled)

41. (canceled)

42. (canceled)

43. The method of claim 1, wherein (b) comprises separating at least the portion of the hydrogen from the non-hydrogenous gas using one or more of pressure-swing adsorption, membrane separation, cryogenic separation, absorption column, stripping column, gas compressor, and external supply.

44. The method of claim 1, further comprising, after (a), separating the carbon particles from the non-hydrogenous gas.

45. The method of claim 1, further comprising providing an energy input to generate the plasma, wherein the energy input per kilogram hydrogen produced is at least about 15% less for a gas mixture comprising at least 50 mol % non-hydrogenous gas as compared to another gas mixture comprising greater than or equal to about 80 mol % hydrogen.

46. The method of claim 45, wherein a total energy input to obtain the carbon particles and the hydrogen is within about 10% for a gas mixture comprising at least 50 mol % non-hydrogenous gas as compared to another gas mixture comprising greater than or equal to about 80 mol % hydrogen.

47. The method of claim 1, wherein greater than or equal to about 90% of the non-hydrogenous gas provided to the reactor is returned to the reactor in the separated gas.

48. (canceled)

49. The method of claim 1, further comprising, prior to (a), providing the non-hydrogenous gas to the reactor in presence of the plasma and in absence of the hydrocarbon feedstock for a time period sufficient for the reactor to reach thermal steady state.

50. The method of claim 1, further comprising, in (a) or (d), providing a gas mixture comprising at least 50 mol % of the non-hydrogenous gas and hydrogen to the reactor to generate the carbon particles or the additional carbon particles.

51. The method of claim 50, wherein the carbon particles or the additional carbon particles have a dibutyl phthalate (DBP) absorption of at least about 100 milliliters per 100 grams of carbon particles (mL/100 g).

52. (canceled)

53. The method of claim 1, further comprising providing a first gas to the reactor with the hydrocarbon feedstock to initiate a reaction to generate the carbon particles and the hydrogen.

54. The method of claim 53, wherein the first gas comprises greater than or equal to about 80% hydrogen.

55. The method of claim 1, further comprising using a quench gas to cool the carbon particles, the additional carbon particles, the effluent gas, the additional effluent gas, or any combination thereof.

56. The method of claim 55, wherein the quench gas is generated from the effluent gas, and wherein the quench gas comprises from about 0.1 mol % to about 4 mol % hydrocarbons.
